(19) United States
(12) Patent Application Publication
(10) Pub. No.: US 2012/0209631 A1
(43) Pub. Date: Aug. 16, 2012

(54) SYSTEM AND METHOD FOR PROCESSING DATA RELATED TO A LIFE INSURANCE POLICY HAVING A DEATH BENEFIT PAYABLE BASED ON AGE OF A LIVING INSURED

(75) Inventors: Michael J. Roscoe, South Windsor, CT (US); Edwin Clifford Barron, JR., Suffield, CT (US); Lisa Michelle Proch, North Haven, CT (US); Haobo Li, Simsbury, CT (US)

(73) Assignee: HARTFORD FIRE INSURANCE COMPANY, Hartford, CT (US)

(21) Appl. No.: 13/082,964

(22) Filed: Apr. 8, 2011

Related U.S. Application Data
(60) Provisional application No. 61/441,596, filed on Feb. 10, 2011.

(51) Int. Cl. G06Q 40/00

(52) U.S. Cl. 705/4

(57) ABSTRACT

A computer system for processing of data related to a permanent life insurance policy includes a data storage device storing data indicative of a policy owner, an insured under the policy, and a death benefit amount, payable under the policy to a beneficiary upon death of the insured, and a processor in communication with the data storage device. A withdrawal benefit providing periodic payments to the owner, each payment reducing the amount of the death benefit until reaching a residual death benefit amount, is available on owner request, at a minimum age of the insured, on meeting a condition related to a likelihood of policy lapse prior to death of the insured. The processor is configured to determine whether premium payments in accordance with a schedule will cause the condition to be met.

### CROSS-REFERENCE TO RELATED APPLICATIONS

This application claims priority to and benefit of U.S. Provisional Patent Application Ser. No. 61/441,596, filed Feb. 10, 2011, which application is incorporated herein by reference for all purposes.

### FIELD OF INVENTION

The present invention relates to computer systems, and particularly to computer systems for use in the financial services field, and particularly for processing of data related to life insurance policies.

### BACKGROUND

In the field of life insurance, permanent life insurance policies include whole life and universal life policies. In these policies, in general terms, an owner enters into a contract with an issuer, under which the owner pays premiums to the issuer, and the issuer agrees to pay a beneficiary a face value amount upon death of an insured. The owner and the insured are often the same person. The face value amount is much higher than an annual premium, as the death benefit is based on the risk of mortality of the insured. The policies will remain in effect for the entire lifetime of the insured, subject to payment of required premiums. The policies are often purchased initially to replace the income of the insured, with the death benefit being intended to pay for living expenses, tuition and other expenses of children. The policies, when maintained into the retirement years of the owners, serve as a way to pass wealth to children, with immediate payment of death benefits contrasting with the time periods and complications associated with passing assets from an estate to heirs.

Viatical settlements may be available for owners of permanent life insurance policies to obtain use of death benefit amounts during the lifetime of the insured. In an exemplary viatical settlement, a third party purchases the insurance policy from the owner in exchange for a cash payment. The cash payment represents a discounted portion of the death benefit, depending on the third party's assessment of the mortality of the insured. The third party assumes any obligations to make payments to the insurance company, and designates itself as the beneficiary to receive the death benefit upon the death of the insured.

### SUMMARY

In an embodiment, a computer system for processing data related to a permanent life insurance policy having a death benefit, includes a data storage device storing data indicative of a policy owner, an insured under the policy, a death benefit amount, payable under the policy to a beneficiary upon death of the insured, a schedule of premium payments, and a withdrawal benefit in the nature of periodic payments payable to the policy owner upon request and on condition of the insured being living and having reached a minimum age achieved at a benefit eligibility date, and on condition of a policy protection account having at least a target balance, each payment reducing the amount of the death benefit until a residual death benefit amount is reached; and a processor in communication with the data storage device, the processor configured to: determine a current policy protection account balance based on premium payments received, charges based on policy face value, interest credited on balances and charges based on riders; determine, based on the policy protection account balance, the schedule of premium payments, and the benefit eligibility date, whether premium payments in accordance with the schedule will cause the policy protection account balance to reach the target balance by the benefit eligibility date; and provide an output signal having data indicative of the determination whether premium payments in accordance with the schedule will cause the policy protection account balance to reach the target balance by the benefit eligibility date.

In an embodiment, a computer-implemented method for processing data related to a permanent life insurance policy having an owner and a death benefit payable to a beneficiary upon death of an insured, includes: accessing by a processor from a data storage device data indicative of a prior policy protection account value, a policy face value, rates for one or more charges, and an interest rate; determining by the processor, a current policy protection account balance based on premium payments received, charges determined based on the policy face value and the rates and the interest rate; accessing by the processor from the data storage device data indicative of a schedule of premium payments, a benefit eligibility date and a target balance for the policy protection account, wherein the owner is eligible for a withdrawal benefit in the nature of periodic payments payable to the owner upon request and on condition of the insured being living and having reached a minimum age achieved at the benefit eligibility date, and on condition of the policy protection account having at least the target balance as of the benefit eligibility date, each payment reducing the amount of the death benefit until a residual death benefit amount is reached; determining by the processor, based on the policy protection account balance, the schedule of premium payments, and the benefit eligibility date, whether premium payments in accordance with the schedule will cause the policy protection account balance to reach the target balance by the benefit eligibility date; and providing by the processor an output signal having data indicative of the determination whether premium payments in accordance with the schedule will cause the policy protection account balance to reach the target balance by the benefit eligibility date.

In an embodiment, a non-transitory computer-readable medium has processor-executable instructions stored thereon, which instructions, when executed by the processor, cause the processor to: access from a data storage device data indicative of a prior policy protection account value, a policy face value, rates for one or more charges, and an interest rate; determine a current policy protection account balance based on premium payments received, charges determined based on the policy face value and the rates and the interest rate; access from the data storage device data indicative of a schedule of premium payments, a benefit eligibility date and a target balance for the policy protection account, wherein the owner is eligible for a withdrawal benefit in the nature of periodic payments payable to the owner upon request and on condition of the insured being living and having reached a minimum age achieved at the benefit eligibility date, and on condition of the policy protection account having at least the target balance as of the benefit eligibility date, each payment reducing the amount of the death benefit until a residual death benefit amount is reached; determine by the processor, based on the policy protection account balance, the schedule of premium payments, and the benefit eligibility date, whether premium payments in accordance with the schedule will cause the policy protection account balance to reach the target balance by the benefit eligibility date; and provide an output signal having data indicative of the determination whether premium payments in accordance with the schedule will cause the policy protection account balance to reach the target balance by the benefit eligibility date.

In an embodiment, a computer system for processing data related to a permanent life insurance policy having a death benefit, includes: a data storage device storing data indicative of a policy owner, an insured under the policy, a death benefit amount, payable under the policy to a beneficiary upon death of the insured, and a withdrawal benefit in the nature of periodic payments payable to the policy owner upon request and on condition of the insured being living and having reached a minimum age achieved at a benefit eligibility date, and on a condition related to a likelihood of policy lapse prior to death of the insured, each payment reducing the amount of the death benefit until a residual death benefit amount is reached; and a processor in communication with the data storage device, the processor configured to: determine, based on the schedule of premium payments, and the benefit eligibility date, whether premium payments in accordance with the schedule will cause the condition related to a likelihood of policy lapse prior to death of the insured to be met; and provide an output signal having data indicative of the determination whether premium payments in accordance with the schedule will cause the condition related to a likelihood of policy lapse prior to death of the insured to be met.

In an embodiment, a computer-implemented method for processing data related to a permanent life insurance policy having a death benefit, includes accessing by the processor from a data storage device data indicative of a schedule of premium payments, wherein the owner is eligible for a withdrawal benefit in the nature of periodic payments payable to the owner upon request and on satisfying a condition related to a likelihood of policy lapse prior to death of the insured; determining by the processor, based on the schedule of premium payments, whether premium payments in accordance with the schedule will cause the condition to be met; and providing by the processor an output signal having data indicative of the determination whether premium payments in accordance with the schedule will cause the condition to be met.

In an embodiment, a computer system for processing data related to a permanent life insurance policy having an owner and a death benefit payable to a beneficiary upon death of an insured, includes: a data storage device having stored therein data indicative of the policy owner, the insured, and the death benefit amount; and a processor in communication with the data storage device, the processor configured to: receive data indicative of a request from the policy owner for an accelerated death benefit payment, determine whether the insured has reached a minimum age, responsive to determining that the insured has reached the minimum age, providing an output signal having data indicative of instructions to make periodic payments to the owner, and determine, responsive to each of the periodic payments, a reduced amount of the death benefit.

In an embodiment, a computer system for generating retirement plan illustrations, includes: a storage device storing data indicative of rates and rules for a permanent life insurance policy having a withdrawal benefit, in the nature of periodic payments based in amount on the death benefit and reducing the death benefit until a residual death benefit amount is reached, available based on a minimum age of an insured, and a processor configured to: receive data indicative of a retirement plan for at least an insured, comprising contribution data over a time period, growth data related to the contributions, and retirement income and asset assumptions; generate an illustration for the retirement plan with a permanent life insurance policy having a withdrawal benefit, with premiums reducing the contribution data, the processor being configured to calculate the reduced contribution data and reduced retirement income and asset assumptions, and to calculate and include in the illustration income data based on the withdrawal benefit commencing at the minimum age of the insured.

### BRIEF DESCRIPTION OF DRAWINGS

FIG. 1 is a schematic diagram of an exemplary computer system for implementation of a method and system of the invention.

FIG. 2 is a schematic diagram of an exemplary computer hardware server with networked devices for implementation of a method and system of the invention.

FIG. 3 is a schematic diagram of an exemplary computer server and process flow diagram for implementation of a method and system of the invention.

FIG. 4 provides a timeline showing an embodiment in which the insured is the owner of the policy and collects the accelerated death benefit, with the death benefit being paid.

FIG. 5 provides a timeline showing an embodiment in which the insured is the owner of the policy and collects the accelerated benefit, depleting the death benefit.

FIG. 6 illustrates a timeline showing an embodiment in which the insured is not the owner of the policy, and the owner collects the accelerated benefit.

FIG. 7 illustrates a timeline showing an embodiment in which the accelerated benefit is less than the entire death benefit, and is depleted prior to the death of the insured.

FIG. 8 illustrates a timeline showing an embodiment in which an accelerated benefit based on longevity is paid to the owner, and a an accelerated benefit based on a medical condition is subsequently paid, until the death of the insured.

FIG. 9 illustrates a timeline showing an embodiment in which an accelerated benefit based on a medical condition is paid to the owner until a recovery by the owner, and subsequently a longevity accelerated benefit is paid.

FIGS. 10A and 10B are a process flow of a method of processing data related to a life insurance policy having accelerated death benefits based on both a medical condition of an insured and age of an insured.

FIG. 11 illustrates a process flow of a method of generating illustrations of life insurance policies having accelerated payments that reduce the death benefit based on longevity of an insured.

FIG. 12 illustrates a network including a wireless device for providing a user interface for receiving instructions, prompting a user and displaying policy documents in connection with a life insurance policy providing for accelerated payments that reduce the death benefit based on longevity of the insured.

FIG. 13 illustrates a process flow of a method of processing data related to determining whether an owner of a life insurance policy having accelerated death benefits that reduce the death benefit based on longevity of the insured is paying sufficient premiums to be eligible for the accelerated death benefits.

FIG. 14 is an exemplary handheld wireless device displaying a communication to an owner of a policy relating to a withdrawal benefit in accordance with an embodiment.

FIG. 15 is a chart showing an exemplary policy funded by a single premium and having a withdrawal benefit in accordance with an embodiment.

FIG. 16 is an exemplary dialog box generated by a system for generating policy illustrations including a withdrawal benefit in accordance with an embodiment.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems and methods for processing of data relating to insurance. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

A challenge faced by individuals performing retirement planning its a risk that the income provided by a retirement plan will be depleted during the individual's lifetime. By way of example, a retirement plan may be designed to provide a certain level of income to an individual through a particular age; some financial planners provide financial plans that provide an income through age 90. Any balance of assets upon death of the individual is to be passed to the heirs, usually the individual's children. However, if the individual lives past 90, there may be no assets available to support an accustomed lifestyle.

In an embodiment of the present invention, a life insurance policy has a death benefit. The policy may be a universal or whole life policy. The death benefit may be based on mortality, and not on premiums paid or an account value. The policy may be another type of permanent life insurance policy. A permanent life insurance policy remains in force for the full life of the insured, subject to payment of required premiums and meeting of any other conditions. In contrast, a term life policy remains in force for a period of years. The permanent life insurance policy may include a benefit, in the nature of a withdrawal benefit, upon the insured reaching a certain age, such as 85, 90 or 95, or another age between 85 and 95, which benefit provides that the owner may receive periodic payments from the insurance company. Each payment reduces the amount of the death benefit. In an embodiment, payments may reduce the amount of the death benefit until a residual or minimum death benefit value is reached. The minimum may be established or calculated as a percentage of the policy face value, for example, and may be determined in accordance with applicable regulatory definitions of life insurance.

The term “age” as used in the present application may represent any manner of reflecting the age of the insured. The age of an individual on a certain date may mean the individual's age as of the individual's most recent birthday, an age as of a most recent contract anniversary, an age by the individual's nearest birthday (whether most recent or next), or another basis. The term “age” may mean a date that corresponds to a future age of the insured. The term “age” does not represent a time period from issue date of a policy or effective date of any policy rider. The age at which the benefit may commence may be fixed at a set and unvarying age as of the date of policy issue or an effective date of a rider.

Each payment may be a proportionate amount of the death benefit when the payments start. For example, each payment may be a value such as 0.5 percent, 1%, 1.5%, 2.0%, or 2.5% on a monthly basis, 5%, 10% or 15% on an annual basis, 1/12 of 5%, 10% or 15%, on a monthly basis, or another value within the ranges of those values. The monthly and annual payment periods are merely exemplary, and payments may be on another basis, such as weekly, once every two weeks, twice each month, once each calendar quarter, or another period.

The owner may have the option of receiving the benefits or declining the benefit payments and maintaining the death benefit unchanged.

In an embodiment, the benefit is implemented in a rider to an insurance policy. In an embodiment, the rider must be purchased at the time of issue of the policy. In another embodiment, the rider may be purchased after issue of the policy and up to a certain age of the insured, such as an age in the range of 55 to 70.

In an embodiment, after a final accelerated death benefit payment is made, the policy may continue in effect, and a death benefit amount may be established in accordance with stored instructions. By way of example, the death benefit amount may be a percentage of the face value or of the death benefit amount prior to a first of the payments. The amount of the percentage may be based on a percentage sufficient to maintain a status of the policy as a life insurance policy under applicable regulations.

The accelerated death benefit may be available on condition that the policy is full paid up. The accelerated death benefit may be available on condition that a shadow account associated with the policy have a positive balance or a non-negative balance, or at least a fixed non-zero positive balance. The minimum fixed non-zero positive balance may be at least as great as an annual premium under the policy. A shadow account balance may be calculated by a sum of all premiums paid less a sum of all charges from the account, such as rider fees, commission charges and charges for insurance. The condition that the policy be fully paid up, or that a shadow account have at least a fixed balance, provides a greater likelihood that the policy will not lapse before the death of the insured, and thus that the insurance company will need to pay the death benefit. On the other hand, if premium payments are required to maintain the policy in force, then there is a possibility that the policy will lapse before the death benefit is paid.

In an embodiment, the amount of the death benefit may be reduced or charges may be made against payments for policies that are not paid up or have a negative shadow account balance.

In an embodiment, the available amount may be a benefit balance equal to the face amount of the insurance policy. The initial benefit balance may be equal to the face amount less policy indebtedness.

In an embodiment, a system may be configured to provide notifications to a policy owner of amounts of premium payments required prior to the minimum benefit age in order to qualify for the accelerated death benefit payments. The notifications may be periodic, such as annually, and may be more frequent in the year prior to the minimum benefit age.

In an embodiment, a target value of a shadow account may be set at policy issue or upon effective date of a rider. The target value is the minimum value of the shadow account at the time that the owner becomes eligible for the benefit. The target value may be stored in a system memory. The target value may be recalculated as a result of certain changes to the policy, which may be changes to the policy requested by the owner. These changes to the policy may include: a change in the face amount of the policy, a change in the insurance class of the insured, other riders added to the policy or removed from the policy, and increases or decreases to benefits provided by riders attached to the policy. In the event of such a policy change, the insurance company may determine a new target value of the shadow account to be stored and communicated to the owner via new policy specification pages or a policy endorsement.

The shadow account, which is also called the policy protection account, has a value which may be determined as follows. A policy protection account may have a one section or multiple sections. In an embodiment, a policy protection account may include Section A and Section B. The balance of a policy protection account, or of a section of a policy protection account, may be based on premiums paid on the policy, interest credited on a balance of the policy protection account, administrative charges, a charge rate based on the initial or later policy face amount, charges based on riders,

The benefit may be referred to as a guaranteed minimum withdrawal benefit, as an alternative to an accelerated death benefit.

In an embodiment, withdrawals from the policy in excess of the accelerated death benefit payments may not be available. Restrictions may be placed on withdrawals in excess of the accelerated death benefit payments, such as a restriction on any withdrawals made within a period prior to the first accelerated benefit payment. Alternatively, any withdrawals from the policy in excess of the benefit payments may not be permitted either at any time after a first benefit payment, or during a period after a first benefit payment, such as a period of at least 3 to 5 years after a first benefit payment.

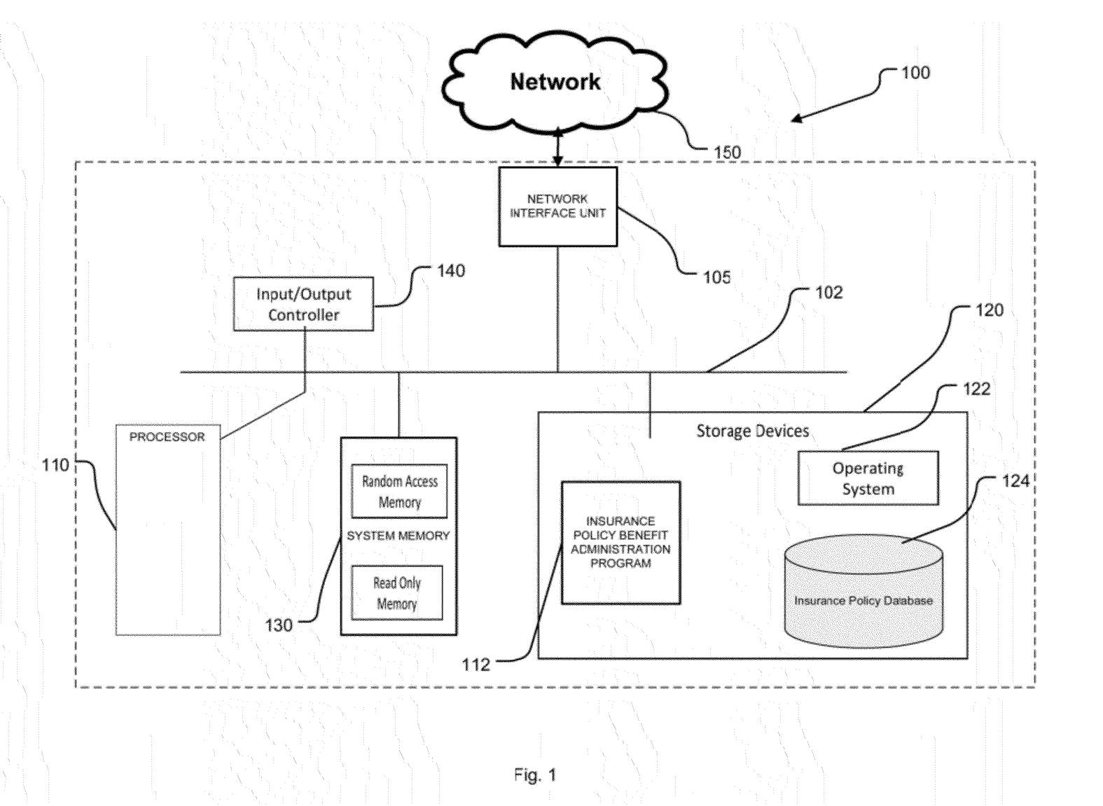

Referring to FIG. 1, an exemplary computer system 100 for use in an implementation of the invention will now be described. In computer system 100, processor 110 executes instructions contained in programs such as investment fund with insurance policy administration application program 112, stored in storage devices 120. Storage devices 120 may include suitable media, such as optical or magnetic disks, fixed disks with magnetic storage (hard drives), tapes accessed by tape drives, and other storage media. Processor 110 communicates, such as through bus 102 and/or other data channels, with network access unit 105, system memory 130, storage devices 120 and input/output controller 125. Via input/output controller 125, processor 110 may receive data from user inputs such as pointing devices, touch screens, audio inputs and keyboards, and may provide data to outputs, such as data to video drivers for formatting on displays, and data to audio devices. Storage devices 120 are configured to exchange data with processor 110, and may store programs containing processor-executable instructions, and values of variables for use by such programs. Processor 110 is configured to access data from storage devices 120, which may include connecting to storage devices 120 and obtain data or read data from the storage devices, or place data into the storage devices. Storage devices 120 may include local and network accessible mass storage devices. Storage devices 120 may include media for storing operating system 122 and mass storage devices such as insurance data storage 124 for storing data related to policies and insureds Such data may include data regarding policies, insureds, owners, cash balances, shadow accounts and other relevant data. In an embodiment, inputs may include user interfaces, including workstations having keyboards, touch screens, pointing devices such as mice, or other user input devices, connected via networked communications to processor 110. Network interface unit 105 may communicate via network 150 with other insurance company computer systems, computer systems of brokers, financial advisors, insureds and owners, computer systems of banks and other financial institutions that effect payments of premiums under the policy and payments of benefits under the policies, remote sources of data, and with systems for implementing instructions output by processor 110. Network 150 may be or include wired or wireless local area networks and wide area networks, and over communications between networks, including over the Internet. Any suitable data and communication protocols may be employed.

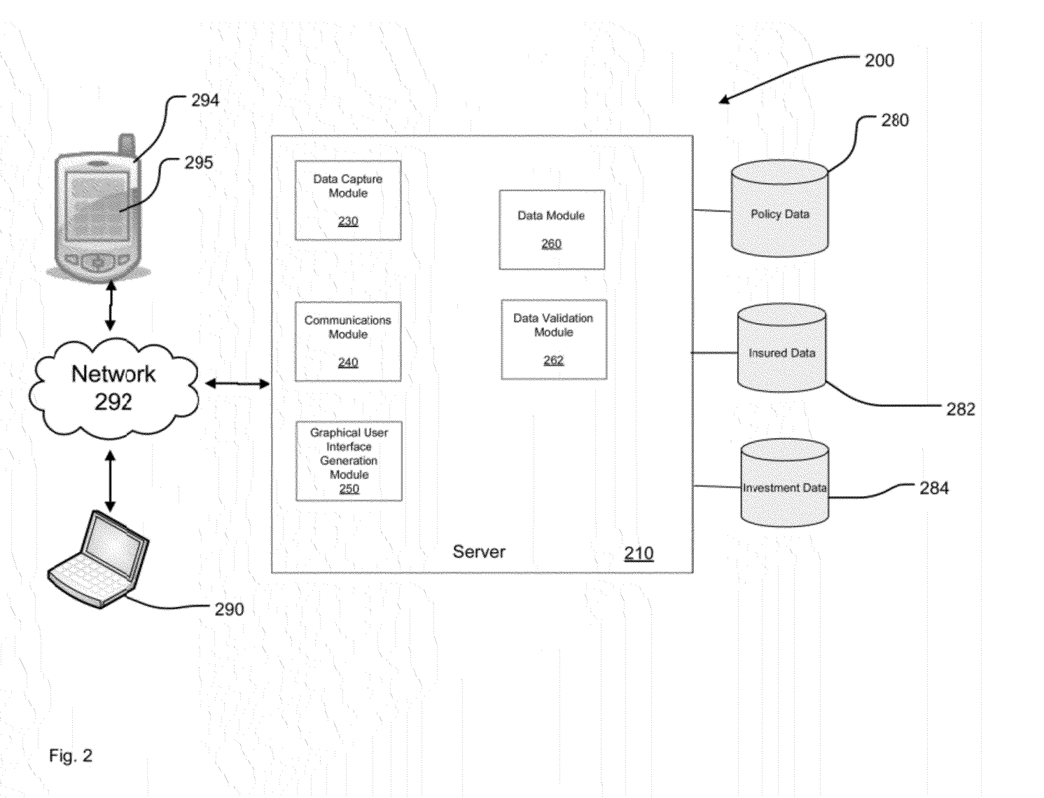

Referring now to FIG. 2, another exemplary embodiment of a system 200 of the present invention is shown. System 200 includes an insurance company server 210 which includes one or more engines or modules which may be utilized to perform one or more steps or functions of the present invention. In an embodiment, the present invention is implemented as one or more modules of a computer software program in combination with one or more components of hardware. Such software programs will be used generally where a policy owner, insured, broker or financial advisor or other representative of an insured or owner has sent a request for data or information to a server and comprises part of the processing done on the server side of the network. The program may be used in an Internet environment, where the server is a Web server and the request is formatted using HTTP (or HTTPS). Alternatively, the server may be in a corporate intranet, and extranet, or any other type of network. Use of the term “Internet” herein, when discussing processing associated with the user's request, includes these other network environments, unless otherwise stated. Additionally, a graphical user interface or insurance processing module may be implemented as an intelligent hardware component incorporating circuitry comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. One or more functions of a web client or other module may be implemented as application software in the form of a set of processor-executable instructions stored in a memory of a client device, such as smart phone 294, and capable of being accessed and executed by a processor of the client device.

Referring still to FIG. 2, server 210 includes a data capture or input/output module 230, a communications module 240, a dynamic display generation or graphical user interface module 250, a data module 260, a data validation module 262. Data module 260 is in further communication with a number of databases such as insurance policy database 280, insured database 282 and investment database 284. Databases in communication with server 210 may include both internal and/or external/third party databases. By way of example, external databases may include databases of financial services entities containing information relating to policy subaccounts and other policy investments. Server 210 may be configured for bulk upload of data for use in administration of insurance policies, such as data relating to funds in subaccounts or investors and securities, from a third party database or file. One or more modules may be configured to perform data validation steps prior to storing bulk uploaded data. Server 210 may further be configured to permit bulk download of data, such as policy and benefit data, to a client device.

In operation, server 210 is in communication with client devices, such as computer 290 or smart phone 294 via a network which facilitates interaction with server 210 through one or more graphical user interfaces as shown and described herein. As used herein, devices, such as client devices 290, 294 may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Referring still to FIG. 2, utilizing client devices 290, 294, a properly authenticated system user, such as a policy owner or a financial advisor of a policy owner, may access policy data relating to policies of the owner. A properly authenticated system user may provide instructions for payment of premiums, commencement of benefits, changes in amounts of benefits, payments of withdrawals, and other transactions using a user interface 295 on smart phone 294, for example. An instruction for a benefit payment may result the server causing policy information to be updated, including calculations of an updated reduced death benefit amount, calculations of amounts of other policy values, such as no lapse guarantee premium amounts, and formatting and sending instructions to a check printing and mailing system to print and mail a check for the amount of the benefit, to the policy owner. A properly authenticated system user may also access policy-related documents, such as statements reflecting current policy values, contracts, riders and registration statements and other documents relating to funds invested in through subaccounts. These documents may be maintained in memory as image files, for example, and available for download and viewing on client devices 290, 294. A properly authenticated individual responsible for administration of policies may access further data. In the present invention, one or more of the above modules, such as graphical user interface module 250, data module 260 and data validation module 270 may also be implemented in combinations of software and hardware for execution by various types of computer processors coupled to such hardware.

As used herein, a module of executable code may, for instance, comprise one or more physical or logical blocks of computer instructions which may, for instance, be organized as an object, procedure, process or function. Nevertheless, the executables of an identified module need not be physically located together, but may comprise separate instructions stored in different locations which, when joined logically together, comprise the module and achieve the stated purpose for the module such as implementing the business rules logic prescribed by the present system. In the present invention a module of executable code may be a compilation of many instructions, and may even be distributed over several different code partitions or segments, among different programs, and across several devices. Similarly, data, including by way of example policy data, insured data and investment data may be identified and illustrated herein within modules, and may be embodied in any suitable form and organized within any suitable type of data structure. Such data may be collected as a single data set, or may be distributed over different locations including over different storage devices, and may exist, at least partially, merely as electronic signals on a system and/or network as shown and described herein.

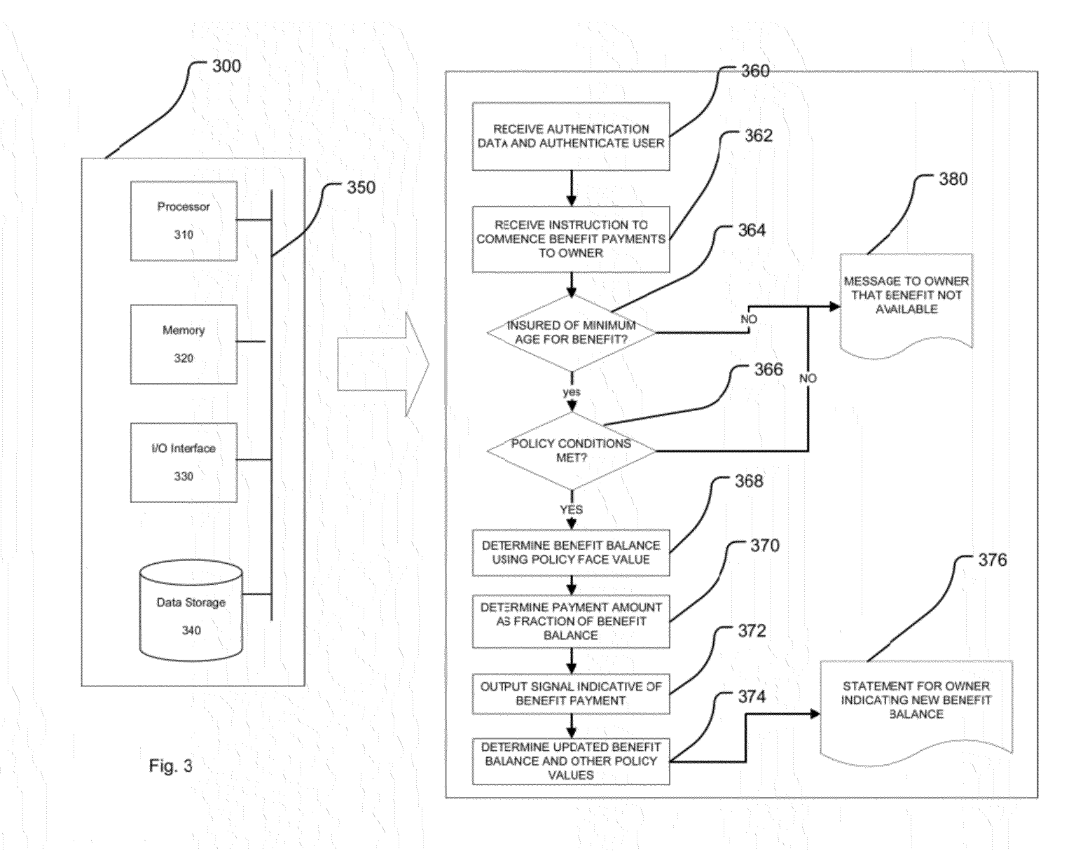

Referring to FIG. 3, in an embodiment, a computer server or client computer 300 running a client application such as a Web browser or a thick client application renders a graphical user interface, such as a series of input screens for viewing and input from a customer or consumer. Server or client computer 300 may include a processor 310, e.g. CPU, memory 320, I/O interface 330 and a storage mechanism 340 coupled together via a system bus 350 over which the various elements may interchange data and information. Computer 300 implements steps 360-374 in accordance with embodiments of the present invention.

Still referring to FIG. 3, computer 300 receives 360 authentication information from an authorized user, such as a policy owner or representative of a policy owner, and authenticates the user. The system receives from the user 362 a request to commence benefit payments. The system may determine, by accessing from data storage 340, whether the insured is of the minimum age (e.g., age 90) for payments 364. The system may also determine whether any other conditions related to timing have been met, such as a first policy anniversary after the insured reaches the minimum age. If the insured is not of the minimum age, then the system outputs 380 a communication to the owner that benefits are not available at present. If the minimum age condition is met the processor may access rules and data to determine whether other policy conditions are met 366 for payment of the accelerated death benefit. Those policy conditions may include whether the policy is paid up, if that is a condition under the policy. If the processor determines that the conditions have not been met, then the processor may output a signal indicative of a message to the owner that the benefit is not available. If the processor determines that the policy conditions have been met, then the processor may determine 368 the benefit balance, using the policy face value and any adjustments to the policy face value. The processor may then determine 378 the amount of each periodic benefit payment as a fraction or percentage of the benefit balance, such as one percent of the benefit balance as the payment for each month. The processor may then output a signal 372 indicative of instructions for a first benefit payment, such as to a payment fulfillment system that prints and mails checks, or to a system that is in communication with the insurance company's bank and can effect an electronic payment. The processor may determine updated benefit balances and other policy values 374. The system may cause a statement 376 to be generated and printed and mailed to an owner, may available on a secure website or other electronic resources, e-mailed or otherwise delivered.

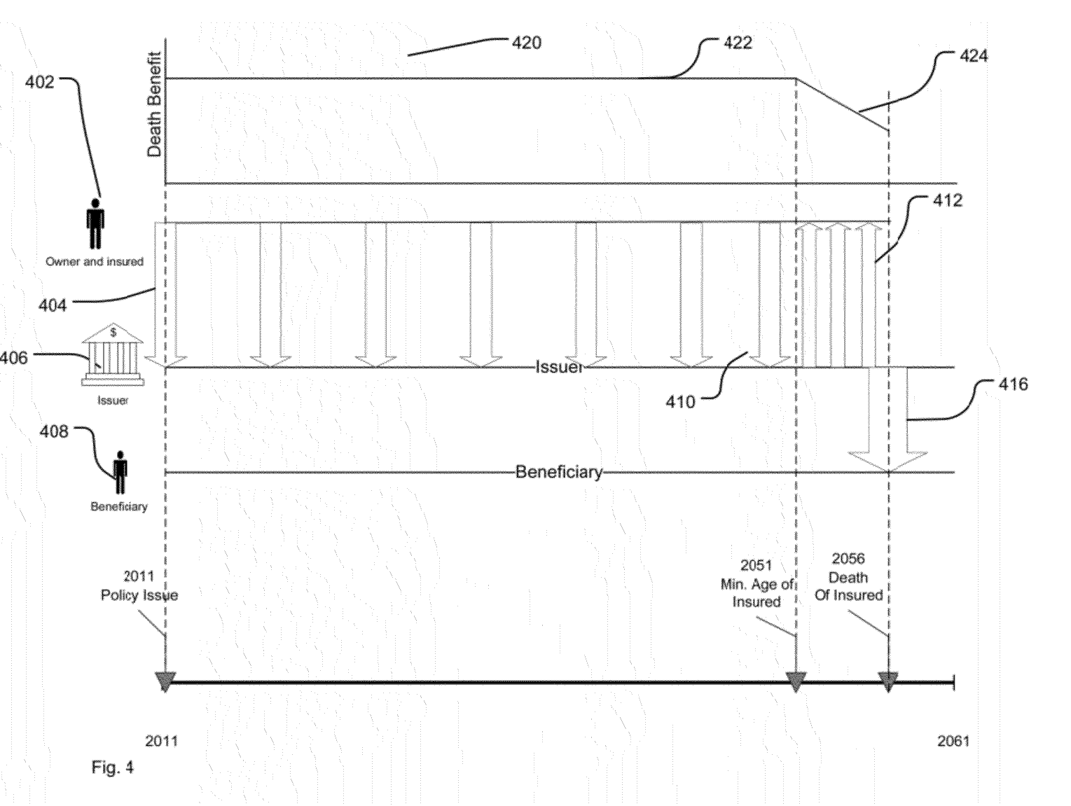

Referring to FIG. 4, a timeline is provided showing an example in which the insured is the owner of the policy and collects the accelerated death benefit, with the death benefit being paid. At the time of policy issue, shown here as 2011, the owner 402 commences payment of premiums 404 to issuer 406. The owner may have an age of 50 at policy issue in 2011. The policy designates a beneficiary 408, who will receive the death benefit under the policy upon death of the insured. The owner 402 continues to pay premiums 404 to issuer 406 until the policy is fully paid up, at 410. When the owner reaches the minimum age provided under the policy to receive accelerated benefit payments, here at the year 2051, when the owner has achieved age 90, the owner requests accelerated benefit payments, and the accelerated benefit payments 412 are made by the issuer to the owner. The death benefit, shown in graph 420, had remained level 422, until commencement of the accelerated benefit payments, which reduce the amount of the death benefit gradually, as indicated at 424. Each accelerated benefit payment reduces the amount of the death benefit. Before the death benefit is depleted, the insured dies, in 2056, at age 95. Upon death of the insured, the remaining death benefit 416 is paid to the beneficiary. No further accelerated benefit payments are made after the death of the insured.

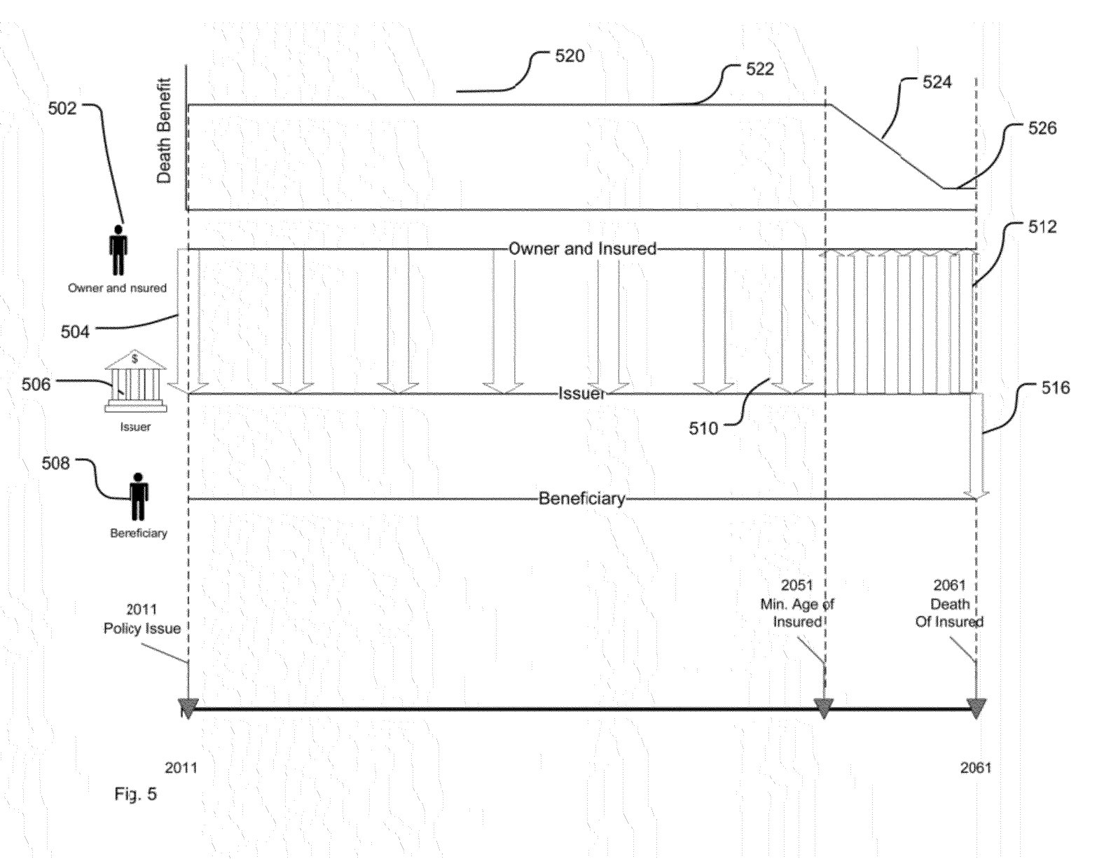

Referring to FIG. 5, a timeline is provided showing an embodiment in which the insured is the owner of the policy and collects the accelerated benefit, depleting the death benefit to a minimum value. At the time of policy issue, shown here as 2011, the owner 502 commences payment of premiums 504 to issuer 506. The owner may have an age of 50 at policy issue in 2011. The policy designates a beneficiary 508, who will receive the death benefit under the policy upon death of the insured. The owner 502 continues to pay premiums 504 to issuer 506 until the policy is fully paid up, at 510. When the owner reaches the minimum age provided under the policy to receive accelerated benefit payments, here at the year 2051, when the owner has achieved age 90, the owner requests accelerated benefit payments, and the accelerated benefit payments 512 are made by the issuer to the owner. The death benefit, shown in graph 520, had remained level 522, until commencement of the accelerated benefit payments, which reduce the amount of the death benefit gradually, as indicated at 524. Each accelerated benefit payment reduces the amount of the death benefit. The accelerated benefit payments continue until the amount of the accelerated benefits is equal to the death benefit at the time that the death benefits commenced. The accelerated benefit payments then cease. A residual death benefit, shown at 526, is determined and maintained as a level death benefit, once the payments reduce the death benefit to the level of the residual death benefit. Upon the death of the insured, in 2061, at age 100, a death benefit 516 is paid by the issuer to the beneficiary. The amount of the death benefit 516 is equal to the residual death benefit 526. The residual death benefit may be determined based on a formula, such as a percentage of the face amount.

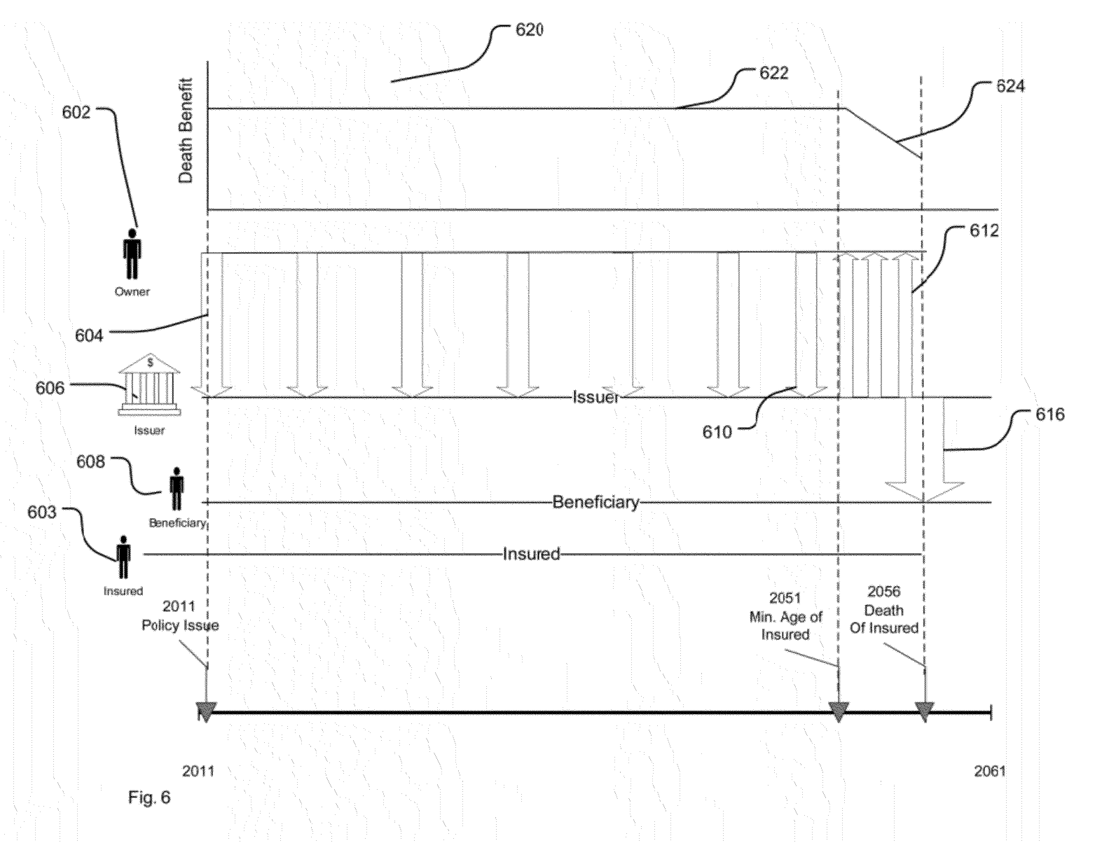

Referring to FIG. 6, a timeline is provided showing an embodiment in which the insured is not the owner of the policy, and the owner collects the accelerated benefit until the death of the insured. By way of example, the owner and the insured may be spouses. At the time of policy issue, shown here as 2011, the owner 602 commences payment of premiums 604 to issuer 606. The insured may have an age of 50 at policy issue in 2011. The policy designates a beneficiary 508, who will receive the death benefit under the policy upon death of the insured. The owner 502 continues to pay premiums 504 to issuer 506 until the policy is fully paid up, at 510. When the insured reaches the minimum age provided under the policy to receive accelerated benefit payments, here at the year 2051, when the insured has achieved age 90, the owner requests accelerated benefit payments, and the accelerated benefit payments 612 are made by the issuer to the owner. The death benefit, shown in graph 620, had remained level 622, until commencement of the accelerated benefit payments, which reduce the amount of the death benefit gradually, as indicated at 624. Each accelerated benefit payment reduces the amount of the death benefit. Before the death benefit is depleted, the insured dies, in 2056, at age 95. Upon death of the insured, the remaining death benefit 616 is paid to the beneficiary. No further accelerated benefit payments are made after the death of the insured.

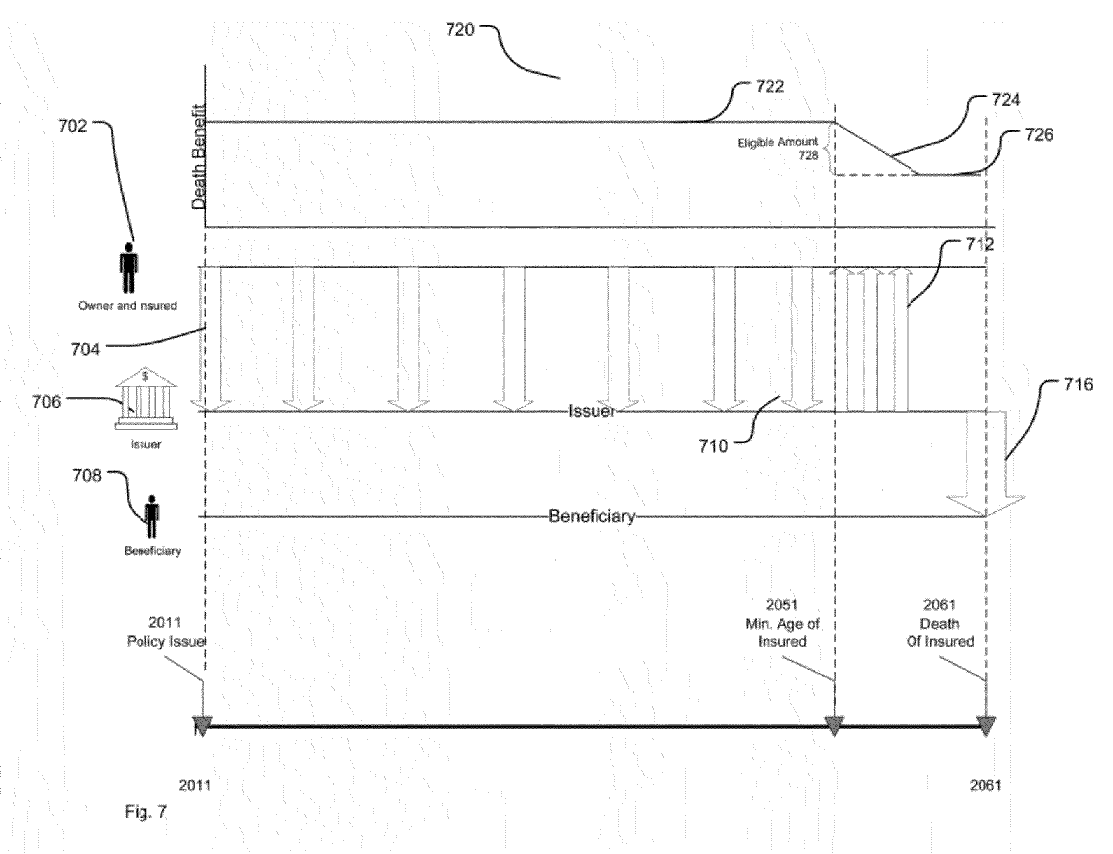

Referring to FIG. 7, a timeline is provided showing an embodiment in which the accelerated benefit is less than the entire death benefit, and is depleted prior to the death of the insured. At the time of policy issue, shown here as 2011, the owner 702 commences payment of premiums 704 to issuer 706. The owner may have an age of 50 at policy issue in 2011. The policy designates a beneficiary 708, who will receive the death benefit under the policy upon death of the insured. The owner 702 continues to pay premiums 704 to issuer 706 until the policy is fully paid up, at 710. When the owner reaches the minimum age provided under the policy to receive accelerated benefit payments, here at the year 2051, when the owner has achieved age 90, the owner requests accelerated benefit payments, and the accelerated benefit payments 712 are made by the issuer to the owner. The death benefit, shown in graph 720, had remained level 722, until commencement of the accelerated benefit payments, which reduce the amount of the death benefit gradually, as indicated at 724. Each accelerated benefit payment reduces the amount of the death benefit. The total accelerated benefit available is an eligible amount 728 which is less than the death benefit at the time of commencement of the accelerated benefit payments. For example, the total accelerated benefit available may be a percentage of the death benefit at the time of commencement of the accelerated benefit payments. The accelerated benefit payments fully deplete the eligible amount 728 prior to the death of the insured. The accelerated benefit payments cease, and the death benefit amount remains level, as indicated at 726. No further accelerated benefit payments are made after the depletion of the eligible amount. Upon death of the insured, at age 100, the remaining death benefit 716 is paid to the beneficiary.

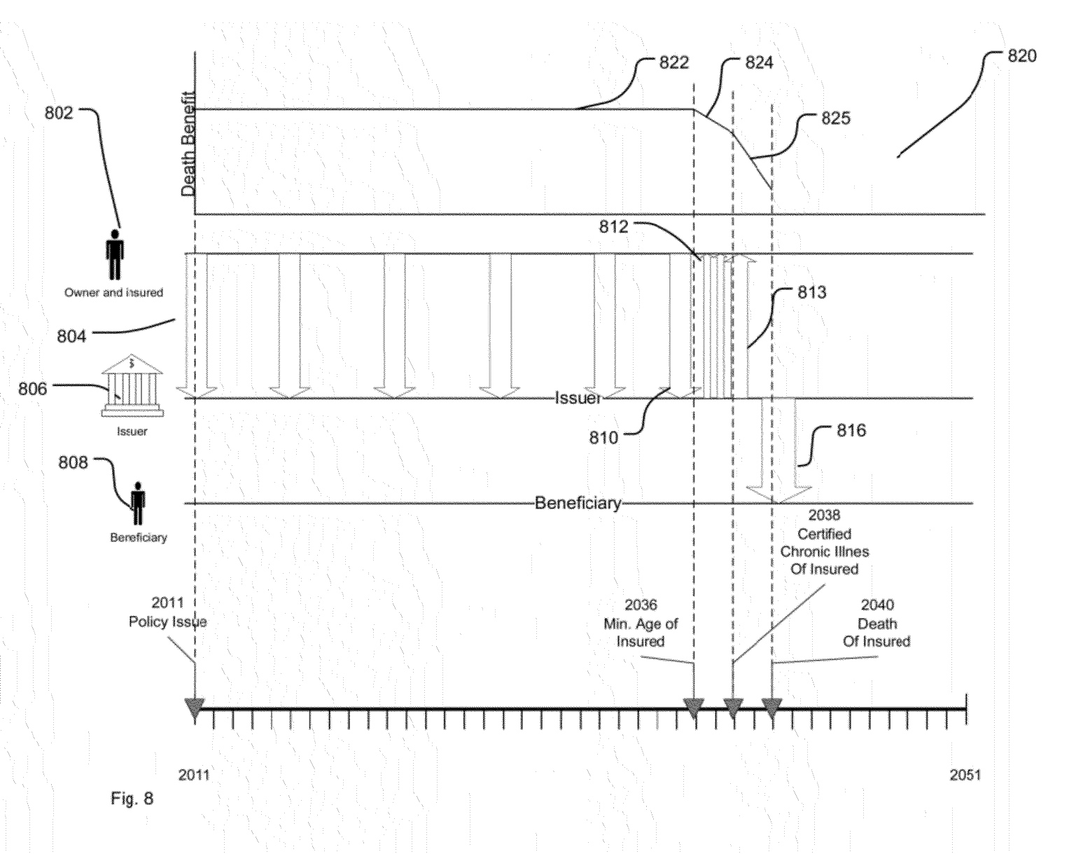

Referring to FIG. 8, a timeline is provided showing an embodiment in which an accelerated benefit based on longevity is paid to the owner, and an accelerated benefit based on a medical condition is subsequently paid, until the death of the insured. At the time of policy issue, shown here as 2011, the owner 802 commences payment of premiums 804 to issuer 806. The owner may have an age of 60 at policy issue in 2011. The policy designates a beneficiary 808, who will receive the death benefit under the policy upon death of the insured. The owner 802 continues to pay premiums 804 to issuer 806 until the policy is fully paid up, at 810. When the owner reaches the minimum age provided under the policy to receive accelerated benefit payments, here at the year 2036, when the owner has achieved age 85, the owner requests accelerated benefit payments, and the accelerated benefit payments 812 are made by the issuer to the owner. The death benefit, shown in graph 820, had remained level 822, until commencement of the accelerated benefit payments, which reduce the amount of the death benefit gradually, as indicated at 824. Each accelerated benefit payment reduces the amount of the death benefit. Two years after the commencement of the accelerated benefit payments, the insured is certified as chronically ill, in accordance with a policy provision or rider. Accelerated benefits under the chronic illness provision commence. In this example, the benefit payments under the chronic illness provision are greater in amount than the longevity-based accelerated benefit payments. For example, the longevity-based accelerated benefit payments may be, in this example, 1% of the death benefit amount prior to the first payment each month. The accelerated benefit payments under the chronic illness provision may be 3% of the death benefit amount prior to the first of the accelerated benefit payments under the chronic illness provision. Thus, for an initial $500,000 death benefit, the monthly longevity-based accelerated benefit payment is $5,000. After two years, the balance of the death benefit is $380,000. The amount of the monthly accelerated benefit payments under the chronic illness provision are calculated based on the death benefit at the time of certification, and are thus $11,400. Before the death benefit is depleted, the insured dies, in 2040. Upon death of the insured, the remaining death benefit 816, in the amount of $106,400, is paid to the beneficiary. No further accelerated benefit payments are made after the death of the insured.

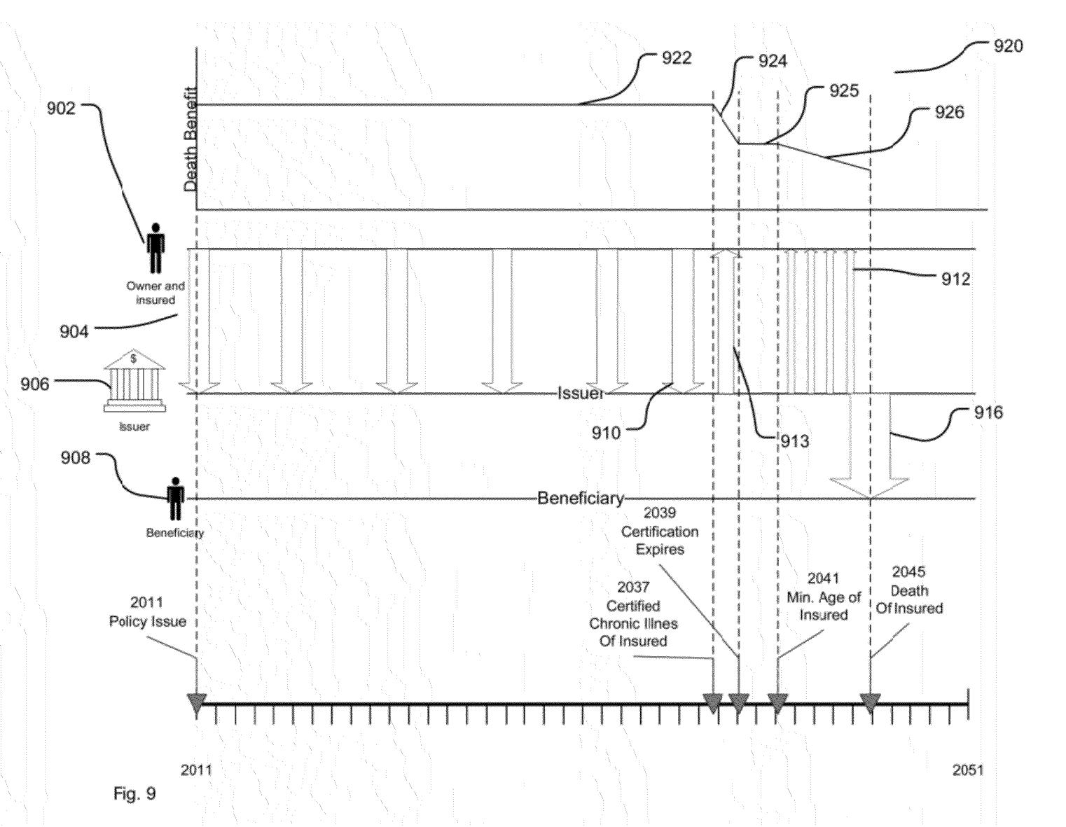

Referring to FIG. 9, a timeline is provided showing an embodiment in which an accelerated benefit based on a medical condition is paid to the owner until a recovery by the owner, and subsequently a longevity accelerated benefit is paid. At the time of policy issue, shown here as 2011, the owner 902 commences payment of premiums 904 to issuer 906. The owner may have an age of 60 at policy issue in 2011. The policy designates a beneficiary 908, who will receive the death benefit under the policy upon death of the insured. The owner 902 continues to pay premiums 904 to issuer 906 until the policy is fully paid up, at 910. The insured is certified as chronically ill, in accordance with a policy provision or rider, in 2037. The owner receives accelerated benefit payments 913 under the chronic illness provision. Each of these payments reduces the death benefit amount. The death benefit, shown in graph 920, had remained level 922, until commencement of the accelerated benefit payments, which reduce the amount of the death benefit gradually, as indicated at 924. Two years after certification of the chronic illness of the insured, the certification expires, in 2039. The certification may expire because the insured has recovered, for example. The certification may expire because no renewed certification is submitted to the issuer. The death benefit remains level, as shown at 925, after cessation of the accelerated benefit payments under the chronic illness provision. When the insured reaches the minimum age provided under the policy to receive accelerated benefit payments based on longevity, here at the year 2041, when the owner has achieved age 90, the owner requests accelerated benefit payments, and the accelerated benefit payments 912 are made by the issuer to the owner. Each accelerated benefit payment reduces the amount of the death benefit, which decreases gradually, as shown at 926. In this example, the accelerated benefit payments 913 under the chronic illness provision are greater than the longevity-based accelerated benefit payments 912. Hence, the rate of decrease of the death benefit at 924 is greater than the rate of decrease of the death benefit at 926. For example, the accelerated death benefit payments under the chronic illness provision may be 2% of the death benefit at the time of certification per month, and the accelerated death benefit payments for longevity may be 1% of the death benefit at the time the insured achieves the minimum age, per month. Thus, for an initial $500,000 death benefit, the monthly benefit based on the chronic illness-based accelerated benefit payment is $10,000. After two years, the balance of the death benefit is $260,000. The amount of the monthly accelerated benefit payments under the longevity provision is calculated based on the death benefit at the time the insured reaches the minimum age. Based on 1% of a $260,000 death benefit, the monthly payments are $2,600. The insured dies in 2045, before the death benefit is depleted. Upon death of the insured, the remaining death benefit 916, in the amount of $135,200, is paid to the beneficiary. No further accelerated benefit payments are made after the death of the insured.

In the foregoing examples, the monthly period of payments is exemplary. Periodic accelerated benefits may be made on any suitable basis, such as annually, quarterly, monthly, bi-weekly or weekly.

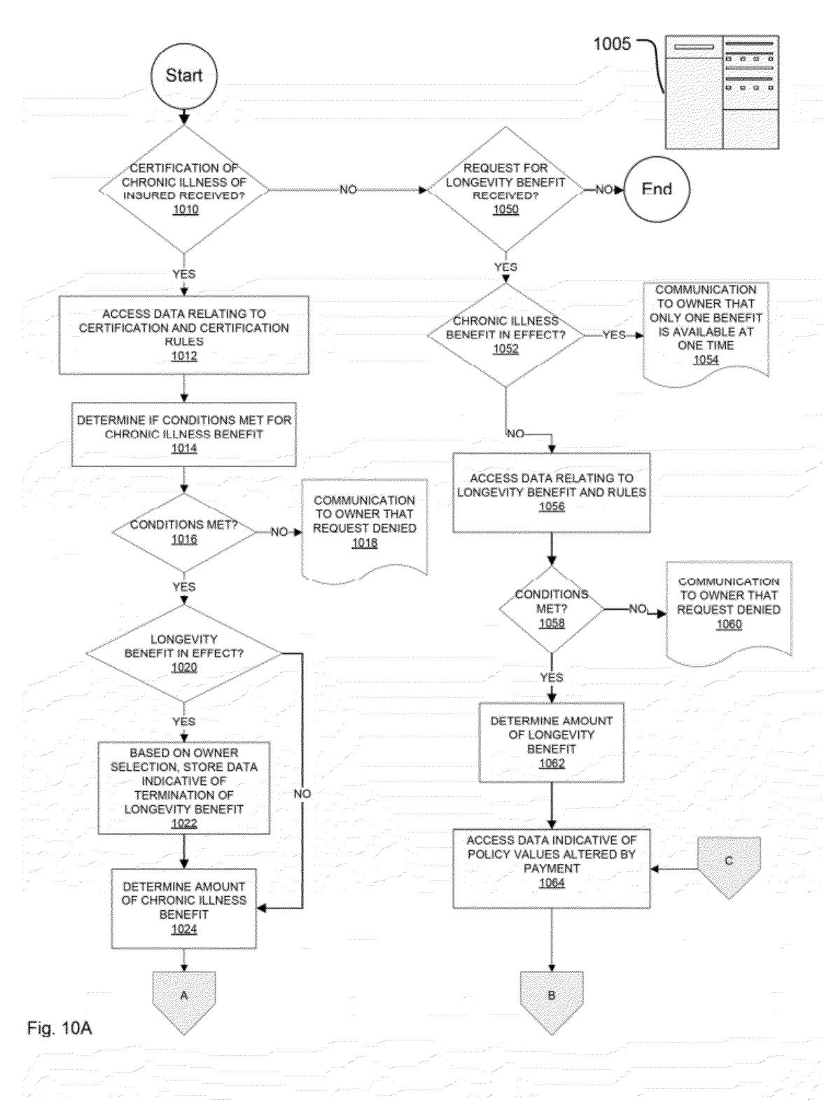

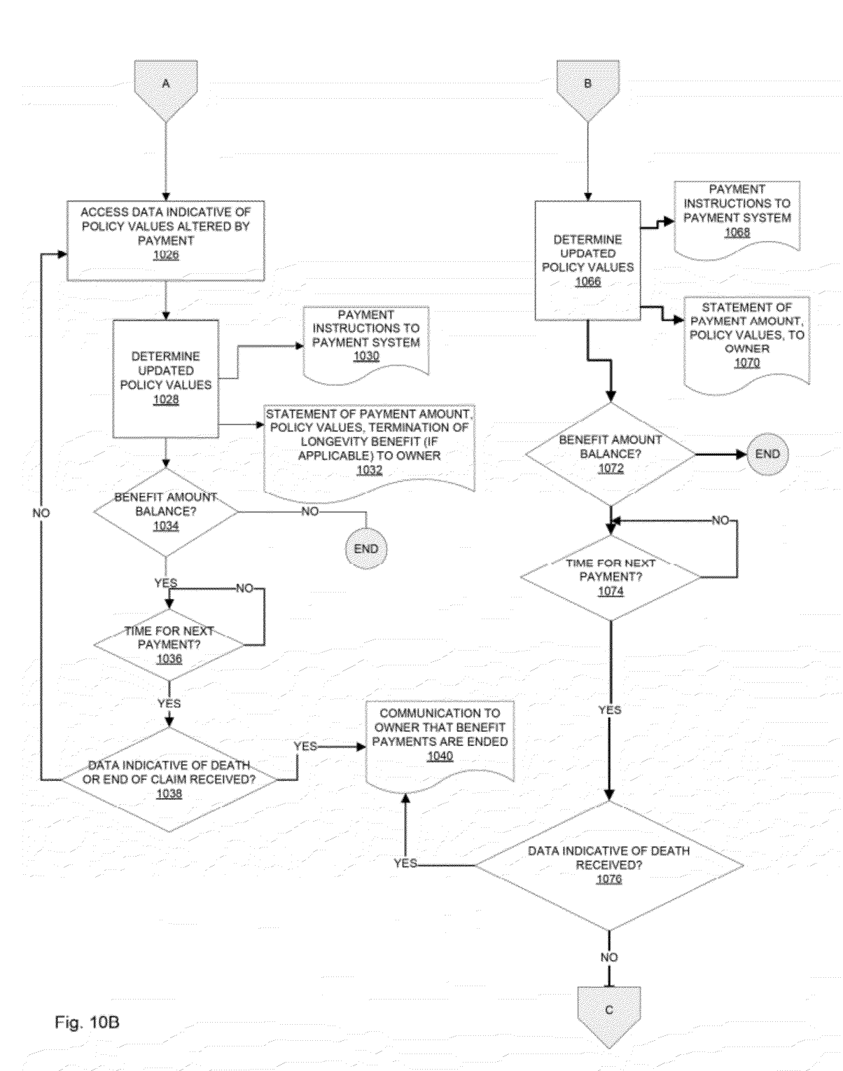

Referring to FIGS. 10A and 10B, a process flow is illustrated of a method of processing data related to a life insurance policy having accelerated death benefits based on both a medical condition of an insured and age of an insured. The process flow steps may be performed by a computer system, such as server 1005 of FIG. 10A. Server 1005 may be in communication with data storage including policy data, insured data, owner data and other relevant data. The process flow may be executed with respect to a particular policy. The process flow may commence with the system determining whether data indicative of a medical condition of the insured, and in particular of a certification of chronic illness of an insured has been received 1010. The benefit based on certification may be independent of the age of the insured. If the system determines that the certification has been received, the system accesses from data storage rules relating to determining whether certification is complete, and data relating to the received certification. Data relating to the rules may include rules setting forth the data elements required for a chronic illness determination, such as whether the certification is completed by a licensed health care practitioner, and whether the certification provides that the insured is at least one of: unable to perform without substantial assistance from another individual at least two activities of daily living and requiring substantial supervision from another individual to protect the insured from threats to health and safety due to a severe cognitive impairment. The particular type of license, including physician, nurse, or other medical professional, and jurisdiction of license, such as U.S. state or territory, or other jurisdiction, may be provided.

The system then uses the rules and the received data to determine 1014 if the conditions have been for the accelerated benefit based on chronic illness or other medical condition of the insured. If the system determines that the conditions have not been met 1016, then the system may output a signal indicative of instructions to provide a communication to the policy owner that the request for the accelerated benefit has been denied 1018. If the system determines that the conditions have been met, then the system accesses data indicative of whether a longevity based accelerated benefit is in effect under the policy 1020. If the accessed data indicates that a longevity based accelerated benefit is in effect, then the system checks for an owner selection of the benefit based on certification of illness. If the owner has not selected one or the other benefit, the system may generate a communication to the owner to provide a selection. If the system accesses data indicative of an owner selection of the chronic illness benefit, then the system stores 1022 data indicative of termination of the longevity based accelerated benefit. If no longevity based accelerated benefit is in effect, then the system proceeds directly to the next step. The system then calculates 1024 the amount of the chronic illness benefit. The maximum amount available for the total chronic illness benefit may be determined based on the then-available death benefit multiplied by a percentage up to 100%. The maximum amount of each payment may be determined based on a percentage of the maximum overall amount. Percentages may be in the range of 1 to 5% for a monthly benefit, for example, or 10% to 50% for an annual benefit. Referring now to FIG. 10B, the system may access 1026 data indicative of policy values updated as a result of a payment, and a formula for determining updated values. Updated values may include face amount, an account value, surrender charges, indebtedness, and no lapse guarantee premiums, by way of example. The values may be determined 1028 to be reduced proportionally in accordance with the proportion of the payment amount to the death benefit prior to the commencement of payments. The system may output instructions 1030 to a payment system to effect payment to the owner in the determined payment amount, and may output instructions for a communication to the owner of the termination of the longevity benefit payments, if applicable, the amount of the payment, and the determined updated values. The system may generate a statement 1032 for delivery to the owner, including payment amount, policy values, termination of longevity benefit, if applicable, and if the available benefit balance is zero, an indication that this is the last payment. If the benefit amount balance is null 1034, then the process ends. If there is a benefit balance, then, at the time for the next periodic payment 1036, the system checks to see if data indicative of death of the insured, or termination of the claim, such as by expiration of a certification or receipt of an indication that the insured no longer meets the requirements for the medical condition, has been received 1036. If such information has been received, then the system generates a communication 1040 to the owner that benefit payments are ended. Otherwise, the process flow returns to accessing data indicative of values to be changed, and continues from there.

If, returning to FIG. 10A, there is a request for longevity benefit received 1050, then the system checks to determine if a chronic illness benefit is in effect 1052. If a chronic illness benefit is in effect, then the system generates a communication to the owner that one benefit must be selected for receipt at any one time 1054. Otherwise, the system accesses data related to the longevity benefit and conditions, such as minimum age, and paid up status of the policy 1056. If the conditions have not been met 1058, then the system generates a communication to the owner that the request has been denied 1060. If the conditions have been met, then the system determines 1062 the amount of the longevity benefit, based on the death benefit amount, the percentage of the death benefit available for longevity payments, and the percentage of the eligible amount available for each individual payment. The system may access 1064 data indicative of policy values updated as a result of a payment, and a formula for determining updated values. Updated values may include face amount, an account value, surrender charges, indebtedness, and no lapse guarantee premiums, by way of example. Referring to FIG. 10B, the values may be determined 1066 to be reduced proportionally in accordance with the proportion of the payment amount to the death benefit prior to the commencement of payments. The system may output instructions 1068 to a payment system to effect payment to the owner in the determined payment amount, and may output instructions 1070 for a communication to the owner of the amount of the payment, and the determined updated values. The system may generate a statement for delivery to the owner, including payment amount, policy values, termination of longevity benefit, if applicable, and if the available benefit balance is zero, an indication that this is the last payment. If the benefit amount balance is null 1072, then the process ends. If there is a benefit balance, then, at the time for the next periodic payment 1074, the system checks to determine whether data indicative of death of the insured has been received 1076. If such information has been received, then the system generates a communication 1040 to the owner that benefit payments are ended. Otherwise, the process flow returns to accessing data indicative of values to be changed, and continues from there.

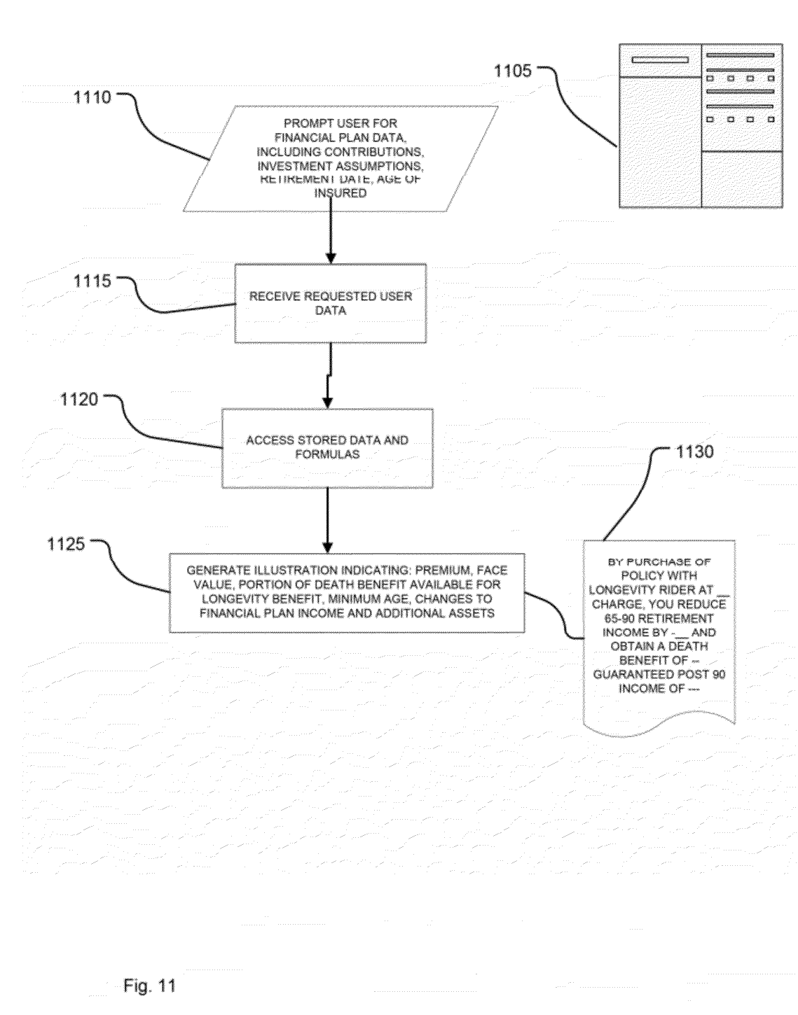

Referring to FIG. 11, a process flow is illustrated of a method of generating illustrations of enhancing individual retirement financial planning with life insurance policies having accelerated payments that reduce the death benefit based on longevity of an insured. Server 1105 may carry out the indicated steps, via communication with a user-accessible device such as a personal computer, notebook, smartphone, tablet computer or other device connected via one or more wired or wireless networks, including the Internet. The server 1105 may cause the user-accessible device to display 1110 a screen prompting the user for financial plan information, such as planned contributions, assumptions as to growth of planned contributions, investment selections, retirement date or dates, assumptions for income after retirement, substantial expenditures, and other data. The server 1105 may receive 1115 the requested data from the user-accessible device. The server 1105 may access 1120 stored data and formulas relating to permanent life insurance policies with riders for accelerated death benefits payable based on an age of the insured, including applicable rates for the riders and amounts of benefit. The server then generates 1125, and causes to be displayed on the user-accessible device, an illustration which includes the premiums, face value and death benefit of the policy, portion of the death benefit available for the longevity benefit, minimum age, changes to financial plan contributions due to diversion of portion of contributions to premiums, resulting changes to income and assets available, and an indication of the additional income available after the minimum age. As indicated at 1130, the illustration may indicate the amount of the charge, the reduction in annual income during a retirement period, such as ages 65-90, the amount of the death benefit, and additional income available after age 90.

For example, the financial plan may be based on a level annual contribution amount for a period of years, e.g., $20,000 per year for 30 years. The plan annually credits the balance of the plan with interest, such as at 5% per annum. The plan calls for income beginning at a retirement age, such as 65 or 68, in the form of annual payments until age 90, each of which reduces the plan balance. the plan The addition of an insurance policy with a particular annual premium for 25 years reduces the amount of the annual payments to the plan. The system may recalculate the assets available based on the reduced amount of annual payments.

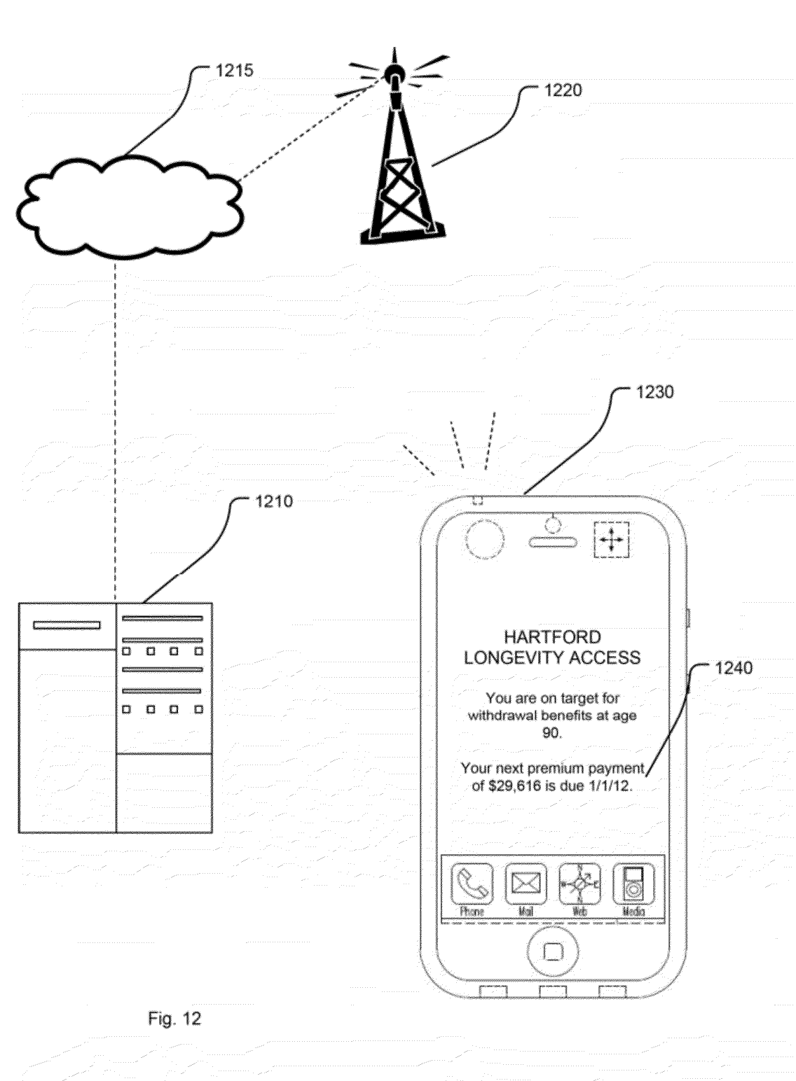

Referring to FIG. 12, a network is illustrated including a wireless device for providing a user interface for receiving instructions, prompting a user and displaying policy documents in connection with a life insurance policy providing for accelerated payments that reduce the death benefit based on longevity of the insured. Hardware server 1240 is an exemplary computer system, such as an insurance company computer system. Hardware server 1240 may include a processor and devices in communication with the processor via a bus, the devices including data storage devices, communications devices, user interfaces, and other devices. Hardware server 1240 may be configured, such as through processor-executable instructions stored as program code in one or more of the data storage devices, to provide the functionality of a computer system for processing data related to permanent life insurance policies having accelerated death benefits available based on longevity of the insured, and for generating illustrations of financial plans incorporating such life insurance policies. Hardware server 1240 is in communication, via network 1230, which may include one or more local area networks, wide area networks and interconnected networks (including the Internet), with a wireless communications network, represented by antenna 1220. The wireless communications network may be a wireless telephone communications network for transmission of voice and data to and from mobile wireless devices, such as cellular telephones, smart phones and computers. Handheld wireless communications device 1210 is in wireless communication with the wireless communications network via antenna 1220. Handheld wireless communications device may be any device capable of bidirectional wireless communications via cellular telephone networks, wi-fi devices, two-way radio, or any other form of wireless communications. Handheld wireless communications device 1210 may be a cellular telephone, smart phone, personal digital assistant, tablet computer, notebook computer, or other type of wireless communications device with a display and processing capability. Via handheld wireless communications device 1210, a user may generate illustrations as discussed with reference to FIG. 11, apply for life insurance policies including accelerated death benefits based on longevity, receive policy documents, including illustrations, binders, policies, and statements, authorize electronic payments of premiums, determine amounts of premiums necessary to qualify for a benefit, submit an application for a benefit, and receive statements related to the benefit, including amounts of periodic payments and adjustments to policy values, including death benefits.

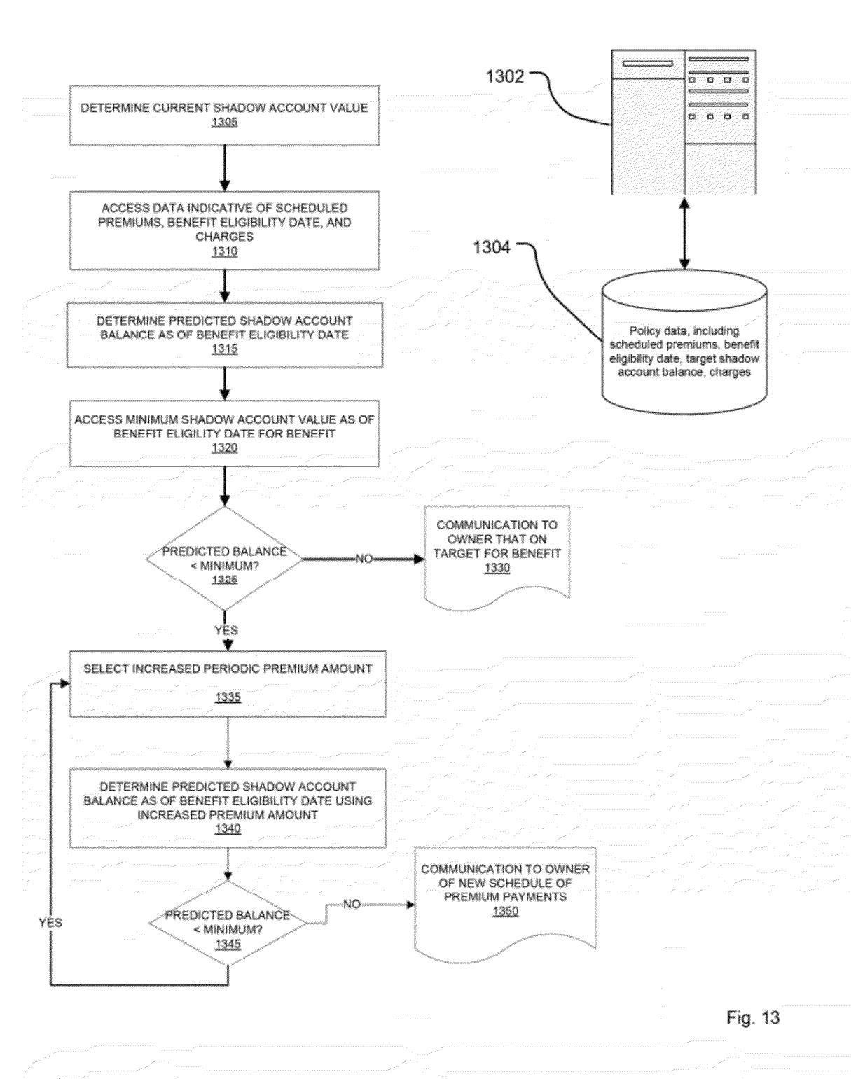

In an embodiment, handheld wireless communications device 1210 may include a processor and memory device or memory devices in communication with the processor, as well as wireless antenna assemblies and one or more displays, such as touch screen displays, in communication with the processor. In an embodiment, a memory device of handheld wireless communications device 1210 has stored therein an application program including processor executable instructions for prompting a user to provide financial plan information, receiving the information, and generating illustrations, as discussed above in connection with FIG. 11. The application programs may retrieve policy information via server 1240 and display policy information, and be configured to prompt for and receive requests to commence payment of accelerated death benefits based on longevity, to accept premium payments, and to perform other processing tasks related to administration of life insurance policies having accelerated death benefits based on longevity. In an embodiment, the device 1210 is configured to determine, as discussed, for example, in connection with FIG. 13, to determine whether the scheduled premiums are sufficient for the owner to meet conditions related to the likelihood that the policy will lapse before payment of the death benefit. The device 1210 may be configured to display the result of the determination, and the amount and due date for the next premium. Any steps described in the present application as being performed by a server-based or other insurance company computer system, by way of example, may be performed, in whole or in part, by a processor of a handheld device executing instructions stored in a non-transitory computer-readable medium of the handheld device.

Referring now to FIG. 13, a process flow is illustrated of a method of processing data related to determining whether an owner of a life insurance policy having accelerated death benefits based on age of an insured is providing sufficient premiums to meet the conditions for the accelerated death benefit. The process may be executed by computer hardware server 1302, which is in communication with data storage device 1304 storing data indicative of policy data for life insurance policies, including scheduled premiums, benefit eligibility date, target shadow account balance, amounts and timing of charges or formulas for charges, and other stored data. Data indicative of scheduled premiums may include due dates and amounts of premiums from a current date until a last date needed to complete payments for the policy to remain fully paid-up through the end of the mortality table, subject to conditions such as that no policy loans are made. For example, the data may include a schedule of dates, each of which is a policy anniversary date, with an associated scheduled payment amount. In an embodiment, the scheduled premiums may be level premiums due yearly on the anniversary of the policy issue date or the policy effective date, for a period of years, such as 10, 15, 20, 25, 30 or 35 years, or another period of years. Data indicative of benefit eligibility date may be a date such as a first policy anniversary after the insured has attained a certain age. A target shadow account balance may be a fixed amount entered from a policy specifications page of an insurance contract upon issue or upon amendment of the contract. Data indicative of charges may include formulas and values of variables in formulas.

A processor may determine 1305 a current shadow account value. A current shadow account value may be stored in a memory location, and the determining may refer to accessing the value from a memory location. The system may determine the current shadow account value using an algorithm represented by stored data. The algorithm may be, by way of example: (Prior shadow account value)+((Premiums paid subsequent to date of prior shadow account value)×(1−(Percentage deducted from premiums))+((Prior shadow account face value)×(credited interest rate))−((Face Value)×(percentage charge for period))−(Amount of withdrawals from policy)−(Amount of loans from policy)+(Amount of loan repayments). The period may be a year, or another time period, such as a calendar quarter or month.

The processor may access 1310 from data storage device 1304 data indicative of scheduled premiums from the present to the benefit eligibility date, the benefit eligibility date, and data indicative of charges. Data indicative of charges may include formulas for charges based on a certain percentage of face value for each year or other time period, for example. The processor may determine 1315 a predicted shadow account balance as of the benefit eligibility date. The determination of the predicted shadow account balance may employ the same algorithm employed in determining the current shadow account balance, iteratively for each time period, such as each year, until the benefit eligibility date. The predicted shadow account balance is then stored in memory. The process may access 1320 the target shadow account value, which may also be termed a minimum shadow account value as of a benefit eligibility date. The processor compares the predicted shadow account balance with the target shadow account balance. If the predicted shadow account balance is not less than the minimum shadow account balance 1325, then the processor may output a signal indicative of a communication to the owner that the owner is on target for eligibility for the accelerated death benefit based on age, assuming that applicable conditions, such as payment of all scheduled premiums in accordance with the amount and date set forth in the schedule, and not taking policy loans, are met. The communication may be dispatched in any suitable manner. By way of example, a printing and mailing system may print on paper and dispatch by postal mail a statement or letter advising the policy owner that the owner is on target for eligibility, and advising of conditions, such as the scheduled premiums and the like. The communication may be provided as data for display on a wireless device, such as handheld wireless communications device 1210.

If the predicted balance is determined to be less than the minimum, the system proceeds to a process of determining a new premium schedule that would permit the owner to meet the minimum shadow account balance by the benefit eligibility date. In the embodiment disclosed in FIG. 13, the system is configured to iteratively test increased periodic premium amounts until an amount is obtained that is sufficient to provide the minimum shadow account balance by the benefit eligibility date. The system selects 1335 an increased periodic premium amount. For example, the increased amount may be determined by increasing each scheduled premium payment by a percentage, such as 1%, or by increasing each scheduled premium payment by a dollar value, such as $100. The system then determines 1340 the predicted shadow account balance as of the benefit eligibility date using the increased periodic premium amount. The predicted shadow account balance may be determined by iteratively adding portions of scheduled premiums to the current balance, and deducting charges, as explained above. The predicted shadow balance obtained using the increased periodic premium amount is then compared to the minimum shadow account balance. If the predicted shadow account balance obtained using the increased periodic premium amount is 1345 less than the minimum shadow account balance, then the process flow returns to the step of selecting an increased periodic premium amount.

Other calculations may be employed to determine a new schedule of premiums. For example, the system may be configured to employ an algorithm that provides a solution equal to a level premium amount that provides the minimum shadow account balance. The system may be configured to determine an increase to the next scheduled premium sufficient to provide the minimum shadow account balance, without change to the following scheduled premiums, for example. The system may be configured to determine a sequence of scheduled premiums that increase in amount by a fixed percentage.

Various owner actions that deviate from the schedule can result in a need to increase scheduled premiums in order to be eligible for the benefit. Delayed premium payments reduce the interest credited to the shadow account. Withdrawals from the policy reduce the value of the account. Loans taken against the policy also reduce the account value. A revised scheduled of premiums may also include a schedule of loan repayments. For example, the system may calculate a series of level payments, in which payments are allocated first to loan repayments and then to premiums, sufficient for the shadow account balance to meet the minimum target value at the benefit eligibility date.

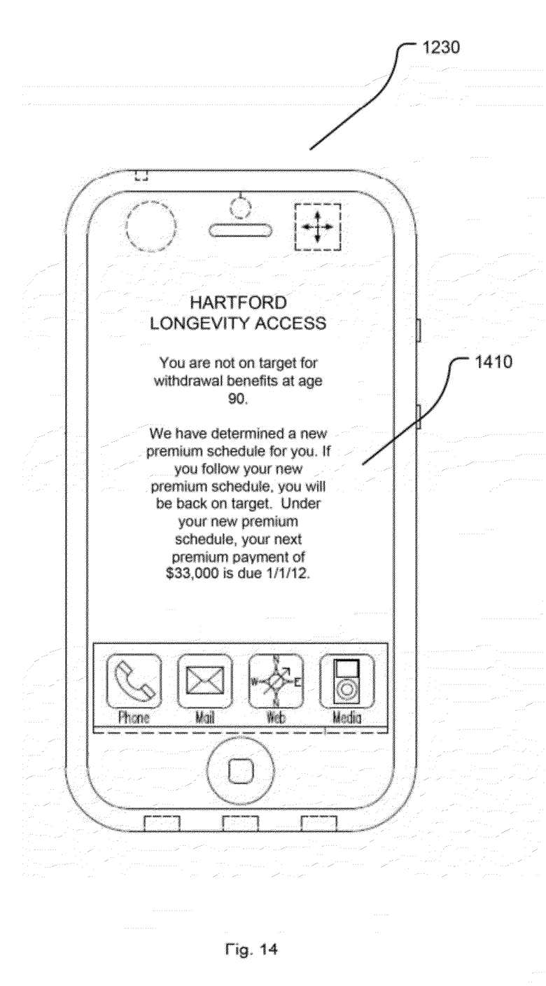

Referring to FIG. 14, the handheld wireless device 1210 may be configured to indicate, as shown at 1410, that the current schedule of premiums is not sufficient, and may display one or more payments of the new schedule of premiums.

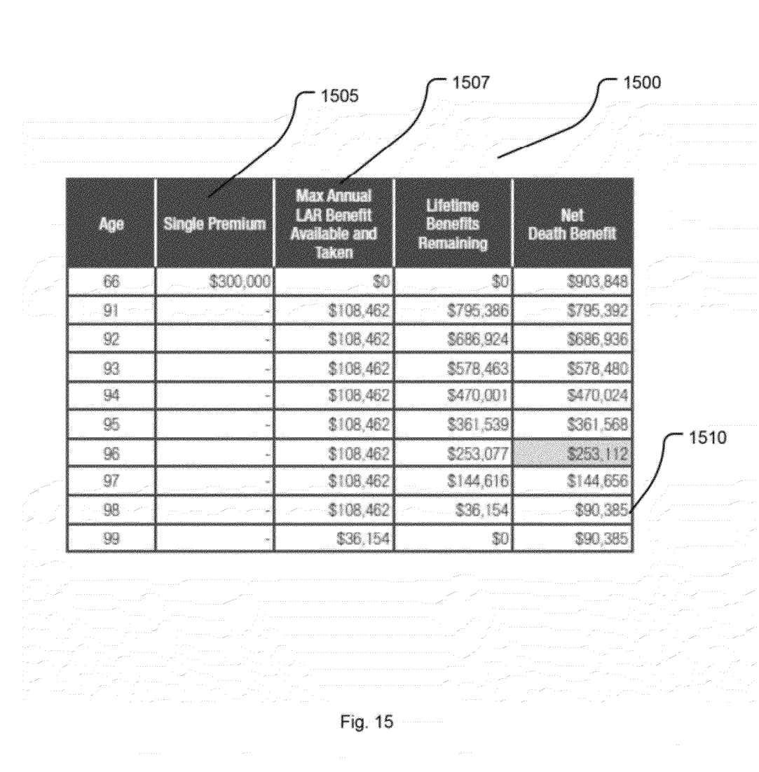

In an example illustrating an embodiment, in chart 1500 of FIG. 15, an owner is issued a life insurance policy at age 66. In this example, a single premium 1505 is paid on policy issue. The single premium is sufficient to pay all charges, and the owner does not make any withdrawals or take any loans. Thus, the owner is eligible for the benefit 1507 on the benefit eligibility date, shown here at age 91. The benefit is completely depleted, but a residual death benefit 1510 is available.

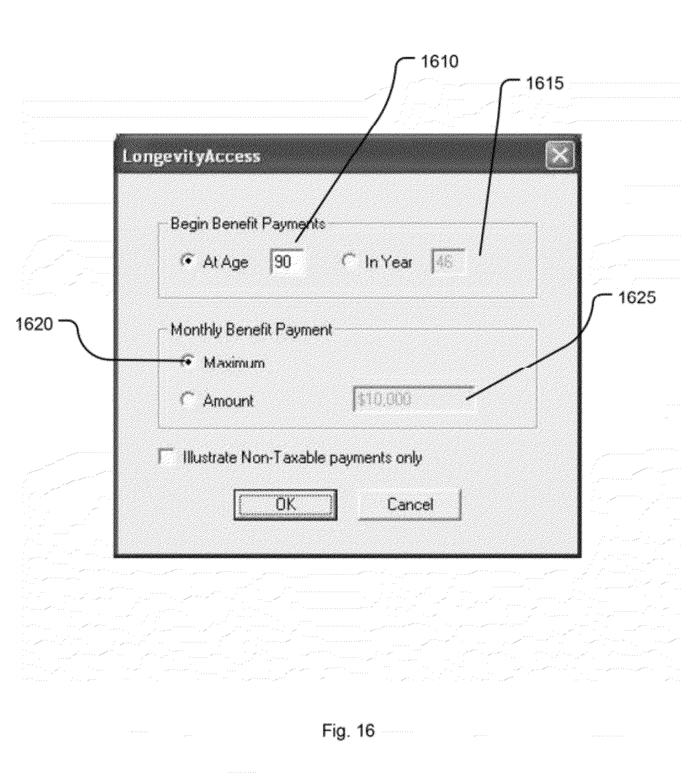

Referring to FIG. 16, a computer system for generating illustrations may generate the display shown in FIG. 16 to prompt the user to indicate a starting age 1610 for the benefit payments, or a year from the policy issue date for the benefit payments. The user is also prompted to select either a maximum available payment 1620 or a dollar value of payments 1625. The illustration system will then calculate benefit payments and reductions in death benefits, and generate an illustration showing benefit payments.

In an embodiment, a rider may provide for the owner, beginning on a Benefit Eligibility Date to: (1) to take Withdrawals each month regardless of the Cash Surrender Value; (2) a guaranteed minimum Death Benefit regardless of the reductions in the Face Amount due to withdrawals; and (3) a guarantee that the policy will not lapse due to insufficient policy value. The issuer may perform a test each month to determine if the benefits provided by the rider are available. If Withdrawals in a month exceed the Guaranteed Minimum Withdrawal Benefit, benefits may not be available in future months.

The Available Benefit Percentage is the percentage that is applied to the Face Amount on the Benefit Eligibility Date to determine the Benefit Balance. The percentage is selected by the owner at the time of Application for the Rider subject to issuer rules in effect. The Available Benefit Percentage is shown in the Policy Specifications.

Benefit Balance: the total amount guaranteed to be available over time to be withdrawn. On the Benefit Eligibility Date, the Initial Benefit Balance is equal to the Face Amount times the Available Benefit Percentage. Thereafter, in any month the Benefit Balance is equal to the lesser of: (a) the Benefit Balance as of the prior month less any Withdrawals taken under the Policy since the prior month; or (b) the current Face Amount.

Benefit Eligibility Date: the first date on which Rider benefits may become available. The Benefit Eligibility Date is shown in the Policy Specifications.

Benefit Index: The Benefit Index is used to determine whether rider benefits are available by comparing to the GMWB Target Value. The Initial Benefit Index on the Benefit Eligibility Date is equal to the Policy Protection Account Value. Thereafter, the Benefit Index is increased by any net premium received, decreased by the amount of any withdrawals in excess of the GMWB and decreased by any withdrawals taken when benefits are not available.

Guaranteed Minimum Withdrawal Benefit (“GMWB”): The GMWB is the amount of Withdrawal that is guaranteed to be available each month that benefits are available. On the Benefit Eligibility Date, the GMWB is set equal to the initial Benefit Balance times the GMWB Percentage shown in the Policy Specifications. When Withdrawals taken in any policy month exceed the GMWB or when Withdrawals are taken in a policy month that benefits are not available, the GMWB is reset on the next monthly activity date. The new GMWB will equal the Benefit Balance after the Withdrawals times the GMWB Percentage shown in the Policy Specifications

GMWB Target Value: The GMWB Target Value is used to determine whether rider benefits are available by comparing to the Benefit Index. The GMWB Target Value on the rider specification page is based on the initial Face Amount. On the Benefit Eligibility Date the GMWB Target Value will be adjusted to reflect any changes to the policy Face Amount after policy issue. The GMWB Target Value on the Benefit Eligibility date equals the GMWB Target Value on the rider specification page multiplied by the ratio of the Current Face Amount to the Initial Face Amount.

Benefits provided by the rider are available on the Benefit Eligibility Date and in any month thereafter while the Rider remains in effect, provided: 1. the Benefit Index equals or exceeds the GMWB Target Value; 2. the Death Benefit Option is Death Benefit Option A (Level); 3. there is no Indebtedness under the Policy; and 4. the Death Benefit is not being accelerated under any accelerated death benefit rider or long-term care rider that may be attached to the Policy. If each of the 4 elements of the test are met on a monthly activity date: the owner is guaranteed to be able to take a Withdrawal from the Policy equal to the lesser of the GMWB or the Benefit Balance regardless of the Cash Surrender Value; the owner's Death Benefit is guaranteed to be at least equal to the Residual Death Benefit regardless of the reductions in the owner's Face Amount due to withdrawals; and the owner's policy will not lapse due to insufficient policy value. The owner may request to withdraw less than the GMWB. A lesser amount could extend the period for which the owner can take monthly withdrawals. Any amount the owner elects to take that is less than the GMWB is subject to Our minimum rules then in effect. If the owner's Death Benefit Option on or after the Benefit Eligibility Date is anything other than Death Benefit Option A, the issuer will allow the owner to change it to Death Benefit Option A without evidence of insurability regardless of what Death Benefit Option is in effect at that time to become eligible for Rider benefits. The Face Amount after the change will equal the Death Benefit immediately prior to the change. The Death Benefit under the Policy at any time while benefits are available under the Rider will never be less than the Initial Benefit Balance times the Residual Death Benefit Percentage shown in the Policy Specifications, regardless of the reduction in Face Amount resulting from Guaranteed Withdrawal Benefits. The Face Amount of the policy will be reduced by the amount of any Withdrawal taken on or after the Benefit Eligibility date. While Rider benefits are available, only the amount of Withdrawals in a month in excess of the GMWB will reduce the Policy Protection Account Value. The monthly premium charge for this Rider will be automatically deducted from each Premium Payment received by Us. Maximum Monthly Rider Premium Charges are shown in the Policy Specifications. On each Monthly Activity Date following the Benefit Eligibility Date, if benefits are available under the Rider and the Account Value less Indebtedness is insufficient to satisfy Monthly Deduction Amounts, the issuer will waive the portion of such deductions which exceed the Account Value less Indebtedness to keep the Policy from going into default.

A policy protection rider may be provided in the underlying insurance policy.

The policy protection rider may provide: for a Policy Protection Account, which is a reference account used solely to determine whether or not the Policy Protection Test has been met, and consists of two sections, Section A and Section B. It is not used to determine the actual Account Value, Cash Value, Cash Surrender Value or Death Benefit provided by the Policy.

Policy Protection Monthly Charge: a charge deducted, on each Monthly Activity Date, from the Policy Protection Account as described in the Policy Protection Monthly Charge section of this Rider.

Policy Protection Net Premium: the premium amount credited to the Policy Protection Account. It is the premium paid into the Policy minus deductions for the Policy Protection Premium Charge and the Policy Protection Regulatory Charge.

Policy Protection Premium Charge: a charge deducted from premiums paid. It is calculated by multiplying premium paid by the applicable percentage as shown in the Policy Protection Rider Specifications Pages.

Policy Protection Regulatory Charge: a charge deducted from premiums paid. It is calculated by multiplying the premium paid by the applicable percentage as shown in the Policy Protection Rider Specifications Pages.

Policy Protection Test: a test used to determine whether the benefit is available.

The Policy Protection Rider benefit, if available, will prevent the owner's Policy from going into default, on any Monthly Activity Date, when the Account Value is not sufficient to cover the Monthly Deduction Amount. If this benefit goes into effect (a) any Monthly Deduction Amounts (attributable to the coverage(s) protected by the Policy Protection Rider benefit) that exceed the Account Value, less Indebtedness, will be waived, and (b) any riders as shown in the Policy Protection Rider Specifications Pages as being protected by this Policy Protection Rider benefit, will continue subject to the terms and conditions of the riders. However, this benefit will not prevent the owner's Policy from going into default when the Indebtedness equals or exceeds the Cash Value. Please refer to the Policy's Termination Due To Excessive Indebtedness provision for more information.

This benefit is available if, on any given Monthly Activity Date, the Policy Protection Test is met. If this benefit is not available, it can be made available at any time by making a premium payment or loan repayment, sufficient to meet the Policy Protection Test. However, if premiums received to restore the availability of this benefit would cause the policy to fail to meet the definition of life insurance (in accordance with the Internal Revenue Code) the excess premiums will be refunded and this benefit will not be available at that time.

The Policy Protection Test is met if the accumulated value in the Policy Protection Account is equal to or greater than zero. If the test is not met, the benefit will not be available.

This benefit will go into effect when the Account Value of the owner's Policy is insufficient to cover the Monthly Deduction Amount provided that the Policy Protection Test is met.

The accumulated value in the Policy Protection Account equals the sum of the accumulated values in Section A and Section B. On the Policy Date, the accumulated value in Section B equals the Policy Protection Net Premium and the accumulated value in Section A equals zero.

On each subsequent Monthly Activity Date, the accumulated value in Sections A and B equals: the accumulated value in the Section on the previous Monthly Activity Date; plus any Policy Protection Net Premium allocated to that Section since the last Monthly Activity Date; plus interest credited at the Section's policy protection credited rate (as shown in the Policy Specifications) since the last Monthly Activity Date; minus the appropriate Policy Protection Monthly Charge taken from the Section on that date (see below); minus any Withdrawals taken from the Section since the last Monthly Activity Date; minus any loans taken from the Section since the last Monthly Activity Date; plus any loan repayments to the Section since the last Monthly Activity Date, Any other adjustment made to the Policy's Account Value will impact the accumulated values in the Policy Protection Account in the same manner.

During the first Policy Year, all premium payments and loan repayments are allocated to Section B of the Policy Protection Account. On the first Policy Anniversary, and thereafter, which Section of the Policy Protection Account premium payments and loan repayments are allocated to depends on the accumulated value of the Policy Protection Account on the date of the payment: if the accumulated value in the Policy Protection Account is greater than zero, the premium payment or loan repayment is allocated to Section B; if the accumulated value in the Policy Protection Account is equal to or less than zero, the premium payment or loan repayment will be allocated to Section A.

The actual amount, timing and frequency of payments allocated to Section A and Section B will affect the accumulated values in the Policy Protection Account and could affect the availability of the benefit provided by this Rider. The Policy Protection Monthly Charge is calculated in the same manner as the Monthly Deduction Amount under the Policy (See the Monthly Deduction section of the Policy) but uses the Policy Protection Rider charges and rates that are set forth in the Policy Protection Rider Specifications Pages. The charges and rates used depends on the accumulated value in Section A. If, on any Monthly Activity Date, the accumulated value of Section A is zero, Schedule B charges and rates will be used. If, on any Monthly Activity Date, the accumulated value of Section A is greater than zero, Schedule A charges and rates will be used. The Policy Protection Monthly Charge will be first taken from Section A until the accumulated value in Section A becomes zero, with any remaining amount taken from Section B (Section B can become negative). Loans or Withdrawals deducted from the accumulated account value in the Policy Protection Account are taken first from Section A until the value in Section A is reduced to zero, with any remaining amount of loan or Withdrawal taken from Section B.

When calculating the policy protection cost of insurance charge, it is necessary to calculate the amount(s) at risk. When calculating the amount(s) at risk it is necessary to calculate the death benefit. The death benefit, for the purposes of calculating the amount(s) at risk is calculated in the same manner as the Policy's Death Benefit except that Account Value is replaced by the accumulated value in the Policy Protection Account. Additionally, when calculating the amount(s) at risk, the Account Value is replaced by the accumulated value in the Policy Protection Account.

The accelerated death benefit based on age of the insured may be provided in a same policy having an accelerated benefit based on disability, cognitive impairment, terminal illness or other medical condition of the insured, as described, for example in U.S. Patent Publication No. 2008/0147447. By way of example, an owner receiving benefit payments as a result of the age of the insured may have the right to submit a claim for benefit payments as a result of a medical condition of the insured; if the claim is approved, the benefit payments based on age may cease, and benefit payments based on medical condition may commence, using the death benefit available as of the start of benefit payments based on medical condition as a base. Similarly, if an owner receives benefit payments based on a medical condition and then recovers and the benefit payments cease, the owner may later receive the accelerated benefit based on age as disclosed herein. In embodiments, an owner may receive both accelerated benefits simultaneously, if the insured qualifies for both accelerated benefits.

Additionally, the insured individual, the owner of the insurance product and the beneficiary of the insurance product may be different individuals or groups. Thus, an individual may purchase an insurance product having a death benefit payable to another individual while maintaining access to the accelerated benefit for the owner.

Furthermore, in one embodiment the owner and the beneficiary under the rider implementation of the accelerated death benefit may be different than the owner and beneficiary of the underlying policy or death benefit. In such a case the beneficiary of the death benefit will receive the death benefit in the event of the insured's death minus any accelerated benefits received by the owner prior to the death of the insured.

The term lifetime benefit amount as used herein may refer to the maximum amount that may be accelerated during the lifetime of the insured individual and while the accelerated benefit remains in effect. The lifetime benefit amount may be equal to:

1. The eligible amount multiplied by the specified percentage.

Where:
(a) Eligible amount on the policy date equals the initial face amount plus any term insurance amount covering the insured individual under the policy, thereafter eligible amount equals current death benefit plus any term insurance amount covering the insured under the policy.
(b) specified percentage equals 100% of the eligible amount, unless the insured individual elected the death benefit option at the time of application for the accelerated benefit, in which case the insured may select a percentage at that time, such percentage generally may not exceed 100% or result in a lifetime benefit amount of less than the minimum rule's of the insurance provider in effect at the time the insurance product is generated. The specified percentage may remain fixed for the life of the accelerated benefit.

The term maximum monthly benefit as used herein may refer to the maximum amount the insured is eligible to receive on a monthly basis.

The owner may elect to receive the accelerated benefit as a monthly or annual lump sum, benefit payment. The maximum monthly benefit may be equal to the lesser of:

1. The benefit amount when the benefit is requested multiplied by the percentage shown in the additional benefits and rider section of the policy specifications.

2. The monthly equivalent of the per diem with a predetermined limit on the maximum per diem amount (e.g. limitation declared by the internal revenue service) not to exceed the daily benefit limit compounded on each policy anniversary.

The maximum monthly benefit may be calculated at the start of each benefit period and may remain fixed during that benefit period.

Benefits may not necessarily accumulate and may not necessarily be payable on a retroactive basis, except as noted under any relevant provision added by the insurance provider. At the start of each new benefit period, the insurance provider may recalculate the insured individual's monthly benefit amount and make any necessary adjustment so that such amount will equal the maximum monthly benefit. If the insured individual previously elected to receive less than the maximum monthly benefit as described below, the insured individual may at this time increase his/her monthly payments up to the maximum.

The amount of monthly benefit payable to the insured individual on a monthly basis will generally equal the maximum monthly benefit as described above, unless the insured individual elects to receive a lesser amount. This amount may be adjusted so that:

1. If the monthly benefit amount exceeds the lifetime benefit amount, the amount payable will be reduced to an amount that equals the lifetime benefit amount.

2. If, at the time of a benefit payment, there is a policy loan outstanding, in an embodiment, a pro-rata reduction to each benefit payment will occur. Such reduction serves to repay a pro-rata portion of the policy loan. Rather than having the benefit payment adjusted, the owner may elect to repay the policy loan directly to the insurance provider.

Periodically, the owner may elect to receive a periodic benefit amount that is less than the available periodic benefit. Choosing a lesser benefit amount results in a lesser reduction of the death benefit.

In an embodiment, a computer system may, at any time determine whether the account value less indebtedness is less than a current periodic deduction amount. The current periodic deduction amount may be a current monthly deduction amount, and may be a sum of those amounts deducted from an account value for such charges as riders, mortality, administrative costs and the like. Responsive to determining that the account value less indebtedness is not less than the current periodic deduction amount, the system may then determine a reduced amount of the current periodic deduction amount such that the account value less indebtedness is not less than a current periodic deduction amount. This reduction in the amount of the current periodic deduction amount may be termed a waiver of costs. The waiver of costs may be provided at any time subsequent to the accelerated benefit commencing, or may be ended if the owner chooses to cease receiving the accelerated benefits.

After each benefit payment, the lifetime benefit amount in effect immediately prior to such payment may be reduced by each monthly benefit amount payable prior to any pro-rata reduction for loan repayments. In addition, each benefit payment may reduce the values and any no lapse guarantee premium in effect at the time of such payment when such values are multiplied by the following reduction ratio. This is discussed in further detail further on. However, for the purpose of this discussion a simplified version of the method used to calculate the reduction ration is presented below:

Reduction Ratio=1−(A/B)

Where:

A=is the monthly benefit payment, and

B=is the eligible amount immediately prior to a benefit payment.

The insurance product's current values that are reduced by each benefit payment based on the reduction ratio are as follows:

Face amount

Amount of any term insurance rider on the insured

Account value

Surrender charges

Indebtedness (if the benefit is permitted while policy loans are outstanding)

Monthly no lapse guarantee premium

Cumulative no lapse guarantee premium

Cumulative premiums (paid to date)

If an accelerated benefit is offered as a rider, the insurance product to which the rider is attached may be any form of permanent life insurance, including a variable life policy. The insurance provider may reduce amounts in the fixed account and each relevant sub-account based on the proportion of the account value in the fixed account and each relevant sub-account to the amount accelerated. The insurance provider may limit the availability of certain sub-accounts while benefit payments are being made.

The insurance provider may send the insured individual a monthly report showing current values under the insured individual's policy, unless the insured individual elects to receive an annual lump sum payment, in which case the insurance provider will send the insured individual an annual report in accordance with the annual report provision of the insurance product. The insured individual may also contact the insurance provider to obtain current information regarding the insured individual's benefits under the insurance product at any time.

If the insured individual makes a withdrawal under the insurance product during a benefit period, the accelerated benefit may terminate in accordance with any relevant rider termination provision.

The charge for the rider for any monthly activity date may be equal to the product of the following factors:

A. The cost of insurance rate per $1,000 for the insurance product.

B. The accelerated benefit factor, such factor never to exceed the maximum determined by the insurance provider for any additional benefits and riders.

C. The benefit size discount factor which may not be less than 0.1 or greater than 1.

D. The accelerated benefit rider amount at risk divided by $1,000.

The charge may automatically be deducted on each monthly activity date from the account value as part of the monthly deduction amount and may not exceed the maximum charge as determined by the insurance provider.

If the account value less indebtedness is insufficient to satisfy monthly deduction amounts while benefit payments are being made, the insurance provider may waive the portion of such deductions which exceed the account value less indebtedness to keep the insurance product from going into default until benefit payments are discontinued either by the insured individual or in accordance with the terms of the accelerated benefit. In an embodiment, the insurance provider may waive the portion of such deductions which exceed the account value less indebtedness to keep the insurance product from going into default for the remaining term of the policy, regardless of whether the benefit payments are discontinued.

The owner may elect to receive his/her monthly benefit amount as an annual lump sum prior to the start of each benefit period. The amount of the annual lump sum payment may equal the present value of the monthly benefit amount payable for each month in the twelve-month period following either the date the first monthly benefit payment would otherwise be payable, or the date of each subsequent benefit period.

Each monthly benefit amount payable will be discounted by a monthly rate, such rate derived from an annual interest rate, never to exceed the greater of the current yield on ninety-day treasury bills, or the current maximum statutory adjustable policy loan interest rate. Such discount may apply prior to any pro-rata adjustment to the monthly benefit amount payable for loan repayments. Only one annual lump sum payment will be made in any one twelve-month period.

In lieu of having the monthly or annual accelerated benefit payments paid by check which the insurance provider mails to the owner, the owner may instead elect to have an interest-bearing draft account (i.e. safe haven account) established in the insured individual's name, the owner may then write drafts as desired, subject to administrative procedures then in effect regarding initial and remaining balances and minimum draft amounts. The insurance provider may discontinue offering the safe haven account at anytime and in such event, any remaining balance in the safe haven account will be paid to the owner in one lump sum.

Charges for an accelerated benefit according to an embodiment of the present invention may continue to be deducted while the insured individual is on claim, unless the base policy has a specific waiver from the insurance provider. Alternatively, charges may not be deducted at all.

In an embodiment, a life insurance policy having an accelerated benefit in accordance with the present invention may have a minimum issue age (e.g. 20 years old), as well as a maximum (e.g. 65 years old). It is possible that, while the base product will be allowed for the insured individual, any rider offered in accordance with the present invention may be turned down.

The insurance provider may charge for the accelerated benefit for the life of the policy, including while the insured individual is on claim under an embodiment of the present invention.

The insured individual may voluntarily terminate an accelerated benefit provision of a life insurance policy in accordance with an embodiment of the present invention at any time. In one embodiment once terminated the insurance product of the present invention cannot be re-added to the given policy. Alternatively, the insurance product in accordance with an embodiment of the present invention may be reinstated at any time even upon termination.

An insurance product according to an embodiment of the present invention may have a maturity date, where the insurance product will terminate at maturity if the policy is not on claim under the rider on the date of termination. An extension for the insurance product may be offered, however the insurance provider may also chose not to offer such extensions.

The insurance product according to an embodiment of the present invention may not terminate if the policy, while not on claim, is being kept in force as the result of an optional no lapse guarantee rider or provision. In the event that the policy is reinstated, the accelerated benefit will be reinstated in the same way all other riders are reinstated.

A policy according to an embodiment of the present invention may not have a separate rate class. Additionally, it may not necessarily be assigned separate substandard table ratings or flat extras. If for example the base insured individual has a rate class of preferred non-smoker with a flat extra of $5 per year for 3 years, then the accelerated benefit may implicitly have a rate class of preferred non-smoker (with the $5 flat extra for three years included in the charges). However, it will not necessarily have this rate class in any explicit manner. It also could not have a separate rate class of standard non-nicotine, for example.

If an accelerated benefit according to an embodiment of the present invention is offered as a rider it may be declined independently of the policy itself. The result of offering an accelerated benefit in accordance with an embodiment of the present invention may simply be to determine whether or not the rider will be allowed, it may not necessarily determine a risk class for the rider.

There may not be separate substandard table ratings associated with the accelerated benefit. However, such separate tables may be used. The base substandard table rating may impact the accelerated benefit charges.

The accelerated benefit may be available for the same rate classes as the base product to which it is being added. It is possible that, for certain highly rated cases the insurance provider may make the accelerated benefit unavailable, this may take place automatically or based on the insurance provider's discretion.

If the insurance product according to an embodiment of the present invention is offered as a rider, the accelerated benefit may be available for the same rate classes as the base product to which it is being added. It is possible that, for cases with higher flat extra amounts the insurance provider may make the accelerated benefit unavailable.

It is possible that an embodiment of the present invention may additionally comprise a base face amount policy limit. For example, an accelerated benefit in accordance with an embodiment of the present invention may not be offered to policies with base face amounts below $100,000 unless the sum total of the base face amount plus face amount on term rider on base insured is greater than or equal to $100,000. Alternatively, no such limits may be imposed. There may also be a limit on the initial benefit amount, which limit may be lower than the face amount, e.g., a limit of $2,000,000 on the initial benefit amount, even if the face amount is larger.

It is possible that, for policies where the base face term face requested is greater than the retention (e.g. $5,000,000), the addition of the accelerated death benefit (“ADB”) to the underlying policy or rider may be declined by the insurance provider.

In an embodiment, the benefit payments may be available only if the level death benefit option has been selected. In other embodiments, there may not be a distinct death benefit option assigned to accelerated benefit. Alternatively, the insurance provider may choose to offer a distinct death benefit option assigned to the accelerated benefit.

All death benefit options available on the given product may be permitted at issue. The insurance provider may elect to restrict the death benefit options to insurance products which include the accelerated benefit, however this is not required.

For all Death Benefit Options except the level death benefit option, the insurance provider may only offer one choice for the percentage of the face value permitted to be used as the benefit. Alternatively, other percentages may be offered to the insured individual. Changes to the death benefit option, the accelerated benefit option, and any relevant base insurance product may be allowed by the insurance provider. Alternatively, such policies or riders may be designated as static with no allowable changes to the insurance product after issue.

Premium payments may be required by the insurance provider while the insurance product is considered on claim under the accelerated benefit. Alternatively, premium payments may not be required while the insurance product is considered on claim. There may not necessarily be distinct surrender charges associated with the insurance product, however such charges may be added.

The insurance provider may choose to reduce surrender charges on a proportional basis with each benefit payment. However, such reductions are not necessary in the implementation of embodiments of the present invention.

There is no distinct interest rate requirement used for embodiments of the present invention. However, an interest rate adjustment may be made to any amount at issue in the insurance product.

There may not be distinct premium load requirements associated with embodiments of the present invention. In one embodiment the premium loads will not be increased. However, an increase in premium load can be made. Additionally, if the accelerated benefit is included in the insurance product, but the insured individual is not receiving benefits under the rider, then withdrawals are allowed as they would be on any intervening base product excluding the rider. Withdrawals may be prohibited during claim period. In the event that an insured individual wishes to take a withdrawal while on claim, she/he may do so if she/he terminates the insurance product of the present invention immediately. Alternatively, withdrawals may be allowed without a termination requirement.

If the accelerated benefit is included in the insurance product but the insured individual is not receiving benefits under the accelerated benefit, then loans may be allowed as they would be on the relevant base product.

The insurance provider may choose to allow loans against the insurance product during claim period. In the event that there is indebtedness on the policy at the time that the policy goes on claim under the accelerated benefit, the indebtedness may automatically be reduced, on a monthly proportional basis, with each claim payment. The net Benefit Amount paid may also be reduced by the amount that is used to pay down the indebtedness on the insurance product.

The cost of the accelerated benefit may be determined using an accelerated death benefit (“ADB factor”). The ADB factor will potentially vary by any or all of the following:

Policy issue age

Gender (male, female, unisex)

These rates may be increased for any base policy substandards, as explained in detail below. It should be noted that in an embodiment the rates for the rider may be decreased for substandard ratings, as an individual insured who receives a substandard rating is less likely to survive until the minimum age to receive the benefit than an insured with a standard or higher rating. Any account charges are deducted from a shadow account for the insurance product if one exists. The shadow account does not actually contain any funds, and is generally used for calculation purposes in order to adjust the actual account value. The charges for an accelerated benefit rider may be deducted when the policy is not on claim under an accelerated benefit provision.

A waiver of monthly deduction rider may be offered along side an accelerated benefit rider. A claim under the waiver of monthly deduction rider may waive at least some charges for an accelerated benefit rider regardless of the claim status under the accelerated benefit. The charges for the accelerated benefit rider may also be deducted when the insurance product is on claim as long as the insurance product is not on claim under the waiver of monthly deduction rider.

The accelerated death benefit percentage of base rate may be applied to the base policy cost of insurance (“COI”) rate and the results of that calculation will then be applied to the accelerated death benefit net amount at risk divided by 1000, on a monthly basis to determine the total charge for the accelerated death benefit.

The values to be used in calculating the accelerated death benefit net amount at risk are defined in the following table below:

| Variable | Description |
|---|---|
| LBAₜ | Lifetime Benefit Amount, time t |
| | It's important to keep in mind that this is defined |
| | somewhat differently before claim and while on |
| | claim - this distinction is critical in this calculation. |
| | See Lifetime Benefit Amount section for details. |
| BaseTermₜ | Face Amount for Term Rider on Base Insured, time t |
| NARₜ | Policy Net Amount at Risk, time t |
| | This will reflect change. to the NAR incurred by any |
| | policy face and/or DBO changes. Refer to the specific |
| | product's specifications for details. |
| NARInc | ADB for LB′ Net Amount at Risk Increment |
| | Fixed value. Currently = 10000 |
| UnitDiv | ADB for LB Unit Divisor |
| | Fixed value. Currently = 6500 |
| RatioFactor | ADB for LB Charge Ratio Factor |
| | Fixed value. Currently 1.075 |
| LBChrgBasisₜ | Accelerated Death Benefit for Living Benefit Charge |
| | Basis, time t |
| LBAP | Living Benefit Specified Percentage |
| MinRatio, | ADB for LB: Minimum Ratio for LB Charge |
| | Fixed value. Currently = 0.1 |
| C | ADB for LB Benefit Size Discount Factor |
| | Calculated value |
| D | ADB for LB NAR |
| | Calculated value |

The formula for the accelerated death benefit net amount at risk is defined as follows:

LBChrgBasisₜ=C*D

where

C=MIN(MAX((RatioFactor−((LBAₜ)/1000)/UnitDiv),MinRatio),1)

and

D=((((NARₜ+BaseTermₜ)*LBAP)NARInc)/1000)

It is important to note that the “C” value is generally a value between MinRatio and 1, inclusive. An illustrative example of an accelerated death benefit net 5 amount at risk is depicted calculation below in the following table:

| | |
|---|---|
| LBAₜ | $5,000,000.00 |
| BaseTermₜ | $150,000.00 |
| NAIRₜ | $3,800,952.36 |
| NARInc | $10,000.00 |
| UnitDiv | $6,5000.00 |
| RatioFactor | 1.07500 |
| LBChrqBasisₜ | 607.09752427 |
| LBAP | 50% |
| MinRatio | 0.10 |
| C | 0.30576923 |
| D | 1,985.47618000 |

There is generally no increase to the accelerated death benefit percentage of base COI rate for any term rider on the base insurance product. However, in an alternative implementations of the present invention an increase to the accelerated death benefit percentage of base COI rate for any term rider on the base insurance product may be implemented.

Since the accelerated death benefit net amount at risk is partly based on the term rider on base insured face amount (if any), the insured individual may incur charges on the accelerated death benefit, if one is included in the insurance product.

The values to be used in calculating the accelerated death benefit charge are defined in the following table:

| Variable | Description |
|---|---|
| t | Policy Month |
| COIₜ | Base Policy Cost Of Insurance Rate. time t |
| | This would also include increases for |
| | substandard ratings, as appropriate. |
| | See specific product's specification, for Cost |
| | of Insurance for more information. |
| LBFactor | Accelerated Death Benefit for Long Term |
| | Care Rider Factor. |
| | This will be a table-driven rate. |
| | At this time, this rate will be issue-aged base |
| | and will not change over the life of the policy. |
| LBChrgBasisₜ | Accelerated Death Benefit for Long Term |
| | Care Services Charge Basis, time t |
| LBRateₜ | Accelerated Death Benefit for Long Term |
| | Care Services Rate per $1000 of LB Net |
| | Amount at Risk, time t |
| | This rate will calculated - see below |
| LBChargeₜ | Total Charge for Accelerated Death Benefit |
| | for Living Benefit Services, time t |

The formula for the accelerated death benefit charge is defined as follows:

LBRateₜ=COIₜ*LBFactor

and

LBChargeₜ=LBRateₜ*LBChrgBasisₜ

In general, the ADB for LB charge should be calculated and treated exactly like the base policy cost of insurance charge. For that reason, the insurance provider may handle scheduled and unscheduled increases differently, as demonstrated through several examples below. It should be noted that both scheduled and unscheduled increases may determine the LB Charge on a segment-by-segment basis.

An example of ADB for LB Charge determination scheduled face increase is described below, all specific values are discussed below for illustrative purposes only and should not serve to limit the invention as the present invention may be applied to a wide variety of values.

On a scheduled increase, COI rates for the increase coverage are point-in scale rates, so the increase piece and the base policy will be charged the same COI rates. In this example, point-in scale rates for the determination of the LB percentage of base COI Rate for the increase may also be used.

In this example of the insurance product according to an embodiment of the present invention takes on the following values:

Policy Month 49 (Year 5 month 1)

5 Baseₜ=$500,000

BaseTermₜ=$150,000

LBAP=50% (0.50)

SchedIncₜ=$250,000

DBₜ=$750,000

NARₜ=675,159.62=policy-level NAR, including face increase

COIₜ=0.3575=Scheduled face increases use point-in-scale COI rates, so increase uses this same rate.

LBFactor=0.525=Delivered in a table, based on policy issue age—the insurance provider may use point-in-scale rates for scheduled increases here as well (i.e. based on base issue age)

Thus, the LB charge for the original base policy calculations are as follows:

BaseNAR=675159.62−250000=425159.62

BaseDB=500000

BaseCOI=0.3575

LBFactor for base=0.525

LBRate for base=0.525*0.3575=0.1876875

LBChrgBasis for base=MIN(MAX((1.075−(500+150)*0.50/6500,0.1),1)*((425159.62+150000)*0.50+10000)/1000=1*30 297.57981=297.57981

LBCharge for base=0.1876875*297.57981=55.85

Consequently, the calculations for LB Charge for the increase segment are as follows:

Incr1NAR=250000

Incr1DB=250000

Incr1COI=BaseCOI=0.3575

LBFactor for incr1=LBPerc for base=0.525

LBFactor for incr1=0.525*0.3575=0.1876875

LBChrgBasis for incr1=MIN(MAX(1.075−(250)*0.5/6500,0.1),1)*((250000*0.50)+10000)/1000=1*135=135

LBCharge for incr1=0.1876875*135=25.34

LBChargeₜ=Charge for base+Charge for increase segment=55.85+25.34=81.19

Below is an example of ADB for LB Charge determination for an unscheduled face increase. On an unscheduled increase, the insurance provider may build a new face segment for the added face amount. COI rates for the increase segment will be based on the insurance product's attained age at the time of the face increase (i.e. the “issue age” for the increase segment), beginning with duration 1. The increase coverage and the base policy may be charged a different rate.

In following this methodology, the insurance provider may calculate the ADB for LB charge on a segment-by segment basis. For the increase segment(s), the insurance provider may pull the associated rates, including the base COI rate and the LB percent of base COI rate, using the issue age for the increase segment(s), not the policy issue age.

The policy's net amount at risk may be split just as it is for the base COI calculation, so the face amount for the increase segment will equal the NAR associated with that segment, and the difference between the whole policy NAR and the increase segment NAR will be the NAR for the base coverage. The insurance provider may choose to pro-rate the death benefit across the segments in the same manner.

In this example the insurance product in accordance with an embodiment of the present invention takes on the following values:

Policy Month 49 (Year 5 month 1)

Baseₜ=$500,000

UnschedIncₜ=$250,000

BaseTermₜ=$150,000

LBAP=0.50 (50%)

DBₜ=$750,000

NARₜ=675,159.62=policy-level NAR, including face increase

BaseCOIₜ=0.3575

Incr1 COIₜ=0.225

LBFactor for base=0.525

LBFactor for increase segment=0.35

Thus, the LB charge for the original base policy calculations are as follows:

BaseNAR=675159.62−250000=425159.62

BaseDB=500000

BaseCOI=0.3575

LBFactor for base=0.525

LBRate for base=0.525*0.3575=0.1876875

LBChrgBasis for base=

MIN(MAX((1.075−(500+150)*0.50/6500,0.1),1)*((425159.62+150000)*0.50+10000)/1000=1*297.57981=297.57981

LBCharge for base=0.1876875*297.57981=55.85

Consequently, the LB Charge for the increase segment calculations are as follows:

Incr1NAR=250000

Incr1DB=250000

Incr1COI=0.225

LBFactor for incr1=0.35

LBRate for incr1=0.35*0.225=0.07875

LBChrgBasis for incr1=MIN(MAX(1.075−(250*0.5)/6500,0.1),1)*(250000*0.50+10000)/1000=135

LBCharge for incr1=0.07875*135=10.63

LBChargetₜ=Charge for base+Charge for increase segment=55.85+10.63=66.48

Some values may be impacted by the inclusion of the accelerated death benefit. For example, the face value and the account value of the insurance product may be reduced when the insured individual or group receive accelerated benefits under the insurance product in accordance with an embodiment of the present invention. In an embodiment the values are reduced proportionally. However, in an alternative embodiment the values maybe reduced using a dollar for dollar reduction.

The proportional reductions described above are calculated using the reduction ratio. The reduction ratio may be applied to the given insurance product value at the time of the benefit payment to determine the new policy value after the benefit payment as been made. The reduction ratio is determined based on the ratio between the benefit payment made and the death benefit plus the term rider on base face amount on the policy prior to that benefit payment. The reduction radio is calculated as follows:

RedRatioₜ=1−[(LBBₜ(DBₜ+BaseTermₜ))]

The Reduction Ratio may not necessarily include the living benefit specified percentage. Proportional reductions are similar to a traditional face decrease, with some differences. Some of these differences are as follows:

It is not only the face amount that may be reduced. As shown above, many other insurance product values are reduced. These proportional reductions are triggered by benefit payments made when the insurance product is on claim under the accelerated death benefit.

The proportional reductions may be made on a monthly basis. A monthly report summarizing the changes to these values may be mailed along with the benefit payment (or, in the event that a safe haven account is used, the report may be sent on its own).

The reduction is based on the reduction ratio.

The face amount on the insurance product may be reduced on a proportional, not dollar-for-dollar, basis. Alternatively, the face amount on the insurance product may be reduced on a dollar for dollar basis. The f for death benefit option A cases, this will (unless in corridor) result in a dollar-for-dollar reduction by the benefit amount, but otherwise, this will not be a true dollar-for dollar reduction.

This reduction may occur on a periodic (e.g. monthly) basis, given that the claim payments may be made periodically (e.g. monthly).

There are two exceptions to this rule. In the event of a death claim or a surrender of the insurance product, the appropriate reduction may be made to the face amount (and, consequently, death benefit) at the time of the death claim or insurance product surrender, even if such an event occurs mid-month.

The account value may be reduced on a proportional basis given the death benefit amount and the benefit amount paid out over the current year.

The reduction in face amount, account value, and cumulative premiums will result in a reduction in the death benefit.

The insurance provider may not necessarily recalculate the maximum monthly benefit amount because of a proportional reduction triggered by a benefit payment.

In the event of indebtedness on the insurance product, the proportional reduction will also reduce the insurance product indebtedness. This reduction in indebtedness will result in a reduction in the net accelerated benefit amount received by the insured individual.

In the event of an accelerated death benefit claim, the insurance provider may process the transactions and calculate values in the following order:

Make the benefit payment for the given month.

Reduce the values above by applying the reduction ratio to each of them.

Determine the monthly deduction amount for that particular month (using the reduced values).

As a result of a benefit payment, product values such as base face amount, term rider on base face amount, account value, death benefit, cash value, cash surrender value, net amount at risk, guideline level premium, MEC (7-pay) premium, no lapse guarantee premium, may be reduced proportionally in accordance with the benefit payment.

However, in an alternative embodiment a dollar for dollar reduction approach may be used. The reduction to the accumulated value will be a proportional reduction, done on periodically (e.g. a monthly basis), and based on the accelerated benefit amount paid out that month and the death benefit as of the end of the previous month. These two items may be used to determine the reduction ratio, which will then be applied to the accumulated value to determine the amount by which it will be reduced.

As a result several values are adjusted as a reduction is performed periodically. Several noteworthy values and the methods by which they are calculated are described in detail below.

In one embodiment, the base face amount will be reduced, on a monthly basis, using the proportional reduction approach. The values to be used in calculating the reduction to the base face amount are defined in the following table

| Variable | Description |
|---|---|
| LBBₜ | Living Benefit Monthly |
| | Benefit Amount paid in month t |
| BaseFaceₜ | Base Face Amount, month t |
| DBₜ | Death Benefit Amount, time t |
| BaseTermₜ | Term Rider on Base Insured |
| | Face Amount, time t |
| RedRatioₜ | Reduction Ratio, time t |

The reduction to the base face amount is calculated as follows:

BaseFaceₜ=BaseFaceₜ*RedRatioₜ

The values to be used in calculating the reduction to the accumulated value are defined in the following table:

| Variable | Description |
|---|---|
| LBBₜ | Living Benefit Monthly Benefit Amount |
| | paid in month t |
| DBₜ | Death Benefit Amount, month t |
| A.Vₜ | Account Value, month t |
| BaseTermₜ | Term Rider on Base Face Amount, time t |
| RedRatioₜ | Reduction Ratio, time t |

The reduction ratio value is calculated as follows:

RedRatioₜ=1−[LBBₜ/(DBₜ+BaseTermₜ)]

Furthermore, the account value at month t is calculated as follows:

AVₜ=AVₜ₋₁*RedRatioₜ

After the proportional reduction of the account value is completed, the monthly processing will continue as specified for the given insurance product.

The surrender charges of the insurance product may be proportionally reduced upon payment of each benefit amount while the insurance product is on claim under the accelerated death benefit.

The values to be used in calculating the surrender charge value are defined in the following table:

| Variable | Description |
|---|---|
| LBBₜ | Living Benefit Monthly Benefit Amount |
| | paid in month t |
| DBₜ | Death Benefit Amount, month t |
| SCₜ | Surrender Charge, month t |
| BaseTermₜ | Term Rider on Base Face Amount, time t |
| RedRatioₜ | Reduction Ratio, time t |

The surrender charge is calculated as follows:

SCₜ=SCₜ₋₁*RedRatioₜ

If and when the insurance product goes on claim under the accelerated death benefit, the insurance product's death benefit will be reduced to reflect the removal of the amount paid under the claim (“benefit amount”).

The methodology used for this reduction will be a proportional reduction approach. The same methodology will be used regardless of the death benefit option on the insurance product. Alternatively, the methodology may be altered as a death benefit is applied.

Since proportional reductions are performed on the base face amount, account value, and cumulative premiums, if the proportional reductions was performed on those pieces first, then it should not be performed a second time when the death benefit is determined using those values.

Alternatively, the proportional reductions may be performed at any time as many times as a particular implementation of the present invention calls for. The method of calculating the death benefit amount at a specific time is discussed in great detail below.

The values to be used in calculating the death benefit amount value are defined in the following table:

| Variable | Definition |
|---|---|
| X | Policy Year |
| T | Policy Month |
| LBBₜ | Gross Monthly Benefit Amount, time t |
| BaseTermₜ | Term Rider on Base Face Amount, time t |
| DBₜ | Death Benefit Amount, time t |
| | This assumes any adjustments for Minimum Death Benefit |
| | requirement (7702). |
| RedRatioₜ | Reduction Ratio, time t |

The death benefit amount is calculated as follows:

DBₜ=DBₜ₋₁*RedRatio₁

On the initial claim date, the lifetime benefit amount will be determined and locked for the duration of the claim.

The insurance provider will then use this locked-in lifetime benefit amount to make sure that the pay out is not in excess for the life of the claim. The total amount paid over the life of the claim should in general not exceed this locked-in lifetime benefit amount.

Outstanding indebtedness on the insurance product at the time that the policy goes on claim under the accelerated benefit may be paid down on a proportion reduction basis. The reduction of the indebtedness will result in a comparable reduction in the benefit amount received by the insured individual while on claim.

In another embodiment, the present invention may additionally comprise a preferred loan provision, where the insurance provider will continue to re-allocation the portion of the debt that's preferred each month, using the proportionally reduced account value and the proportionally reduced cumulative premiums paid to date.

The values to be used in calculating the indebtedness and net accelerated benefit amount paid in a month are defined in the following table:

| Variable | Description |
|---|---|
| LBBₜ | Gross Monthly Benefit Amount paid in month t |
| DBₜ | Death Benefit Amount, month t |
| | This assumes any adjustments for Minimum Death |
| | Benefit requirement (7702). |
| Debtₜ | Policy Indebtedness, month t |
| BaseTermₜ | Term Rider on Base Face Amount, month t |
| NetLBBₜ | Net Accelerated Benefit Rider Benefit |
| | Amount paid in month t |

The indebtedness and net accelerated benefit amount paid in a month are calculated as follows:

Debtₓ=Debtₓ₋₁*RedRatioₓ

and

NetLBBₓ=LBBₓ−(1−RedRatioₓ)*Debtₓ

An additional payment option under an embodiment of the present invention is known as the seven pay (MEC) premium.

Before Claim, including at issue the charges for the insurance product of an embodiment of the present invention will not be included in the determination of seven pay premium on insurance products where an embodiment of the present invention is included as a rider. This approach keeps the death benefit and accelerated benefit rider considered as a single, integrated contract.

In yet another embodiment, the present invention may be implemented as guaranteed insurance. Guaranteed insurance typically guarantees the beneficiary, insured, or owner a fixed payment benefit amount. However, the present insurance product does not require that the benefit amount be fixed, a variable benefit amount may be implemented.

While the policy is on claim under this rider, the insurance provider may handle each benefit payment in a manner comparable to a face decrease for the purposes of tax-related values. The 7-pay premium may be recalculated using the attained age decrement process. This reduction triggered by a benefit payment may not introduce a new 7-Pay period.

In one embodiment of the present invention, there may be a no lapse guarantee charge. The charge for this provision will be included in the calculation of the no lapse guarantee (“NLG”) premiums. It should be added to the total rider charge (“RC”) as appropriate, given the formula for given NLG Premium. The charge calculated for the accelerated benefit should be based on the policy face amount (instead of net amount at risk) for each year of the policy. This will insure that the NLG premium will not vary based on planned premium stream on a given policy.

While not on claim, an insurance product with the accelerated benefit is being kept in force solely as the result of a no lapse guarantee rider or provision, the insurance provider will not terminate the accelerated benefit rider.

In the event that a policy goes on claim under the accelerated benefit and is receiving benefit payments, the no lapse guarantee premium requirement, if one exists for the given product, may not necessarily be waived. In order to keep the no lapse guarantee in effect while on claim, the insured individual will continue to need to meet the no lapse guarantee premium requirement.

The values needed for calculating the face decrease amount triggered by an accelerated benefit claim payment and the cumulative no lapse guarantee premium requirement after reduction for month t are defined in the following table:

| Variable | Description |
|---|---|
| LBBₜ | Gross Monthly Benefit Amount paid in month t |
| DBₜ | Death Benefit Amount, month t |
| | This assumes any adjustments for Minimum Death |
| | Benefit requirement (7702). |
| FaceDecrForLAₜ | Face Decrease Amount Triggered by Accelerated |
| | Benefit Claim Benefit Payment |
| NLGPremOldₜ | No Lapse Guarantee Premium prior to reduction, |
| | month t |
| NLGPremNewₜ | No Lapse Guarantee Premium after reduction, |
| | month t |
| | Recalculated as if a normal Face Decrease equal to |
| | FaceDecrForLAₜ, was taken. |
| | See specific product specification's No Lapse |
| | Guarantee sections for details on how this |
| | recalculation is done. |
| CumlNLGOldₜ₋₁ | Cumulative No Lapse Guarantee Premium |
| | Requirement prior to reduction, month t − 1 |
| CumlNLGNewₜ | Cumulative No Lapse Guarantee Premium |
| | Requirement after reduction, month t |

The face decrease amount triggered by an accelerated benefit claim payment and the cumulative no lapse guarantee premium requirement after reduction for month t are calculated as follows:

FaceDecrForLAₜ,=Faceₜ₋₁*(1−RedRatioₜ)

and

CumlNLGNewₜ=(CumlNLGOldₜ₋₁*RedRatioₜ)+NLGPremNewₜ

The cumulative premiums may be reduced on a proportional basis, using the reduction ratio, after each benefit payment is made. The cumulative premiums may be used, among other things, for determining whether or not the policy's NLG premium requirement has been met (as applicable). These proportionally reduced cumulative premiums may also be used in determining the death benefit for return of premium death benefit option policies.

The values needed for calculating the cumulative premiums paid to date after reduction for month t are defined in the following table:

| Variable | Description |
|---|---|
| LBBₜ | Gross Monthly Benefit Amount paid in month t |
| DBₜ | Death Benefit Amount, month t |
| | This assumes any adjustments for Minimum Death |
| | Benefit requirement (7702). |
| CumlPremOldₜ | Cumulative Premiums paid to date prior to reduction, |
| | month t |
| CumlPremNewₜ | Cumulative Premiums paid to date after reduction, |
| | month t |

The cumulative premiums paid to date after reduction for month t is calculated as follows:

CumlPremNewₜ=CumlPremOldₜ·RedRatioₜ

The calculations described above are presented herein for illustrative purposes only, the methods disclosed herein may be used with a variety of calculation methodologies for calculating specific values. In an embodiment, the calculations described above are performed on a computer system, an embodiment of such a computer system is described below.

In an embodiment, a computer system may implement rules and store data for implementation of a rider in the exemplary form below. This rider may be printed on paper and mailed to a policy owner, faxed, e-mailed, made available via a website, presented to an owner on a handheld device, or otherwise delivered, as may any statement, policy or other document related to a policy. In the exemplary form, the accelerated benefit or living benefit is termed a guaranteed minimum withdrawal benefit.

A processor may provide the central processing unit (CPU) functions of a computing device on one or more integrated circuits. The term “processor” may include multi-core processors and central processing units including multiple microprocessors.

In embodiments, a processor may provide an output signal having data indicative of one or more data items. An output signal may be carried either over a suitable medium, such as wire or fiber, or wirelessly. An output signal may transmit data from one device to another directly, such as over a bus of a computer system from a processor to a memory device, or indirectly, such as over multiple networks, and with intermediate steps of storage in a buffer or memory device and retransmission. Such an output signal may be provided by the processor to a bus of a computer system together with address data at a series of clock intervals. The address data may designate a destination device on a bus, by way of example. In embodiments, an output signal may be a signal output from a hardware communications device of a computer system to a network, such as a local area network, a wide area network, or a network of interconnected networks, such as the Internet. Output signals may include, by way of example, data identifying formats, fields, and content of fields. Signals may be compatible with any appropriate format. For example, data may be formatted in accordance with a data format for insurance data, such as an ACORD compatible format. Reference to an output signal having particular data may include one or more signals bearing the information. Multiple signals bearing the information may include sequences of digital data bearing the information interleaved with sequences of digital data relating to other information. By way of example, a signal may be packetized for transmission. By way of further example, an output signal may take the form of an uncompressed digital signal or a compressed digital signal.

A system on which the methods of embodiments of the present invention may be implemented includes at least one central processing computer or computer network server. Network server includes at least one controller or central processing unit (CPU or processor), at least one communication port or hub, at least one random access memory (RAM), at least one read-only memory (ROM) and one or more databases or data storage devices. All of these later elements are in communication with the CPU to facilitate the operation of the network server. The network server may be configured in many different ways. For example, network server may be a conventional standalone server computer or alternatively, the function of server may be distributed across multiple computing systems and architectures.

Network server may also be configured in a distributed architecture, wherein databases and processors are housed in separate units or locations. Some such servers perform primary processing functions and contain at a minimum, a RAM, a ROM, and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SAS™, ATP, Bluetooth, GSM and TCP/IP.

Data storage device may include a hard magnetic disk drive, optical storage units, CD-ROM drives, or flash memory. Data storage devices contain databases used in processing transactions and/or calculations in accordance with embodiments of the present invention, including at least an insurance subscriber database and an insurance database. In one embodiment, database software creates and manages these databases. Insurance related calculations and/or algorithms in accordance with an embodiment of the present invention are stored in storage device and executed by the CPU.

The controller comprises a processor, such as one or more conventional microprocessors and one or more supplementary co-processors such as math co-processors. The processor is in communication with a communication port through which the processor communicates with other devices such as other servers, user terminals or devices. The communication port may include multiple communication channels for simultaneous communication with, for example, other processors, servers or client terminals. As stated, devices in communication with each other need not be continually transmitting to each other. On the contrary, such devices need only transmit to each other as necessary, may actually refrain from exchanging data most of the time, and may require several steps to be performed to establish a communication link between the devices.

The processor also is in communication with a data storage device. The data storage device may comprise an appropriate combination of magnetic, optical and/or semiconductor memory, and may include, for example, RAM, ROM, flash drive, an optical disc such as a compact disc and/or a hard disk or drive. The processor and the data storage device each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wireline medium or combination of the foregoing.

The data storage device may store, for example, (i) a program (e.g., computer program code and/or a computer program product) adapted to or configured to direct the processor in accordance with embodiments of the present invention, and particularly in accordance with the processes described in detail hereinafter with regard to the controller; (ii) a database adapted to store information that may be utilized to store information required by the program. The program may be stored, for example, in a compressed, an uncompiled and/or an encrypted format, and may include computer program code. The instructions of the program may be read into a main memory of the processor from a non-transitory computer-readable medium other than the data storage device, such as from a ROM or from a RAM. While execution of sequences of instructions in the program causes the processor to perform the process steps described herein, hard-wired circuitry may be used in place of, or in combination with, software instructions for implementation of the processes of embodiments of the present invention. Thus, embodiments of the present invention are not limited to any specific combination of hardware and software.

Suitable computer program code may be provided for performing numerous functions such as calculating a face value for the insurance product, calculating an account value for the insurance product, calculating a death benefit for the insurance product using the account value and the face value, calculating an accelerated benefit for the insurance product using the face value, and account value, and generating an insurance product having an account value, a face value, a death benefit, and a accelerated benefit. The functions described above are merely exemplary and should not be considered exhaustive of the type of function which may be performed by the computer program code of embodiments of the present inventions.

The computer program code required to implement the above functions (and the other functions described herein) can be developed by a person of ordinary skill in the art, and is not described in detail herein.

A computing system may include modules, which may be implemented in hardware, software, or combinations of software and hardware, operably inter-connected via a bi-directional connection with a central serial bus or other bus. A system may include a display module and a generating module. The generating module is used for generating an insurance product contracts and other documents, which documents are then delivered to owners, insureds, beneficiaries, brokers, advisors and others, via any suitable hard copy or electronic method.

The computing system may be in communication with one or more payment systems for effecting payments to owners, insured and beneficiaries.

The term “computer-readable medium” as used herein refers to any medium that provides or participates in providing instructions to the processor of the computing device (or any other processor of a device described herein) for execution. Such a medium may take many forms, including but not limited to, non-volatile media, non-transitory media, tangible media, volatile media, and transmission media. Non-volatile media and tangible media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for execution. For example, the instructions may initially be borne on a magnetic disk of a remote computer. The remote computer can load the instructions into its dynamic memory and send the instructions over an Ethernet connection, cable line, or even telephone line using a modem. A communications device local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Servers of embodiments of the present invention may also interact and/or control one or more user devices or terminals. The user device or terminal may include any one or a combination of a personal computer, a mouse, a keyboard, a computer display, a touch screen, LCD, voice recognition software, or other generally represented by input/output devices required to implement the above functionality. The program also may include program elements such as an operating system, a database management system and “device drivers” that allow the processor to interface with computer peripheral devices (e.g., a video display, a keyboard, a computer mouse, etc).

An exemplary advantage of a method and system of the present invention is that the owner of the policy may receive benefit payments that can supplement retirement savings, while the insurer can provide the benefit at reasonable cost in view of the fact that, once the minimum eligible age of the insured has been reached, the annual mortality rates of the insured is high, and thus the insurer is likely to pay the death benefit within a relatively brief time period. The amount of the death benefit, if any, depends on the length of survival of the insured and thus the need for a supplement to other retirement funding.

While particular embodiments of the invention have been illustrated and described in accordance with administration of insurance policies, various modifications and combinations can be made without departing from the spirit and scope of the invention, and all such modifications, combinations, and equivalents are intended to be covered and claimed.

What is claimed is:

1. A computer system for processing data related to a permanent life insurance policy having a death benefit, comprising:
a data storage device storing data indicative of a policy owner, an insured under the policy, a death benefit amount, payable under the policy to a beneficiary upon death of the insured, a schedule of premium payments, and a withdrawal benefit in the nature of periodic payments payable to the policy owner upon request and on condition of the insured being living and having reached a minimum age achieved at a benefit eligibility date, and on condition of a policy protection account having at least a target balance, each payment reducing the amount of the death benefit until a residual death benefit amount is reached; and
a processor in communication with the data storage device, the processor configured to:
determine a current policy protection account balance based on premium payments received, charges based on policy face value, interest credited on balances and charges based on riders;
determine, based on the policy protection account balance, the schedule of premium payments, and the benefit eligibility date, whether premium payments in accordance with the schedule will cause the policy protection account balance to reach the target balance by the benefit eligibility date; and
provide an output signal having data indicative of the determination whether premium payments in accordance with the schedule will cause the policy protection account balance to reach the target balance by the benefit eligibility date.

2. The computer system of claim 1, wherein the processor is further configured to, responsive to determining that the premium payments in accordance with the schedule will cause the policy protection account balance to reach the target balance by the benefit eligibility date, provide data indicative of instructions to provide a communication to the owner that the owner is on target for eligibility for the withdrawal benefit as of the benefit eligibility date.

3. The computer system of claim 1, wherein the processor is further configured to, responsive to determining that the premium payments in accordance with the schedule will not cause the policy protection account balance to reach the target balance by the benefit eligibility date, determine a new premium schedule that will cause the policy protection account balance to reach the target balance by the benefit eligibility date, and to provide an output signal having data indicative of the new premium schedule.

4. The computer system of claim 3, wherein the processor is further configured to provide data indicative of instructions to provide a communication to the owner of the new premium schedule.

5. The computer system of claim 1, wherein the processor is configured to determine a current policy protection account balance further based on withdrawals from the policy and policy loans.

6. The computer system of claim 1, wherein the processor is further configured to determine a current policy protection account balance by:
accessing a prior policy protection account balance;
adding to the prior policy protection account balance a portion of premiums received subsequent to date of prior policy protection account balance;
adding to the policy protection account balance interest equal to the interest at a credited interest rate on the prior policy protection account balance for a period subsequent to the date of the prior policy protection account balance; and
subtracting from the policy protection account balance a percentage of a policy face value.

7. The computer system of claim 1, wherein the processor is configured to provide an output signal having data indicative of instructions to communicate to the owner that, upon receipt of certification of a medical condition of the insured, and independent of age of the insured, the owner is eligible to receive periodic payments reducing the death benefit.

8. A computer-implemented method for processing data related to a permanent life insurance policy having an owner and a death benefit payable to a beneficiary upon death of an insured, comprising:
accessing by a processor from a data storage device data indicative of a prior policy protection account value, a policy face value, rates for one or more charges, and an interest rate;
determining by the processor, a current policy protection account balance based on premium payments received, charges determined based on the policy face value and the rates and the interest rate;
accessing by the processor from the data storage device data indicative of a schedule of premium payments, a benefit eligibility date and a target balance for the policy protection account, wherein the owner is eligible for a withdrawal benefit in the nature of periodic payments payable to the owner upon request and on condition of the insured being living and having reached a minimum age achieved at the benefit eligibility date, and on condition of the policy protection account having at least the target balance as of the benefit eligibility date, each payment reducing the amount of the death benefit until a residual death benefit amount is reached;
determining by the processor, based on the policy protection account balance, the schedule of premium payments, and the benefit eligibility date, whether premium payments in accordance with the schedule will cause the policy protection account balance to reach the target balance by the benefit eligibility date; and
providing by the processor an output signal having data indicative of the determination whether premium payments in accordance with the schedule will cause the policy protection account balance to reach the target balance by the benefit eligibility date.

9. The computer-implemented method of claim 8, further comprising, responsive to determining that the premium payments in accordance with the schedule will not cause the policy protection account balance to reach the target balance by the benefit eligibility date, determining a new premium schedule that will cause the policy protection account balance to reach the target balance by the benefit eligibility date, and providing an output signal having data indicative of the new premium schedule.

10. The computer-implemented method of claim 9, further comprising providing data indicative of instructions to provide a communication to the owner of the new premium schedule.

11. The computer-implemented method of claim 8, wherein a maximum amount of the withdrawal benefit is based on the death benefit amount as of a date of request for the withdrawal benefit.

12. The computer-implemented method of claim 8, the minimum age is at least 85 years.

13. The computer-implemented method of claim 8, wherein the schedule of premium payments provides a single premium.

14. The computer-implemented method of claim 8, further comprising, responsive to receipt of data indicative of certification of a medical condition of the insured, providing an output signal having data indicative of instructions to provide periodic payments to the owner, the periodic payments reducing the death benefit amount.

15. A non-transitory computer-readable medium, the computer-readable medium having processor-executable instructions stored thereon, which instructions, when executed by the processor, cause the processor to:
access from a data storage device data indicative of a prior policy protection account value, a policy face value, rates for one or more charges, and an interest rate;
determine a current policy protection account balance based on premium payments received, charges determined based on the policy face value and the rates and the interest rate;
access from the data storage device data indicative of a schedule of premium payments, a benefit eligibility date and a target balance for the policy protection account, wherein the owner is eligible for a withdrawal benefit in the nature of periodic payments payable to the owner upon request and on condition of the insured being living and having reached a minimum age achieved at the benefit eligibility date, and on condition of the policy protection account having at least the target balance as of the benefit eligibility date, each payment reducing the amount of the death benefit until a residual death benefit amount is reached;
determine by the processor, based on the policy protection account balance, the schedule of premium payments, and the benefit eligibility date, whether premium payments in accordance with the schedule will cause the policy protection account balance to reach the target balance by the benefit eligibility date; and
provide an output signal having data indicative of the determination whether premium payments in accordance with the schedule will cause the policy protection account balance to reach the target balance by the benefit eligibility date.

16. The non-transitory computer-readable medium of claim 15, wherein the policy is a universal life insurance policy.

17. The non-transitory computer-readable medium of claim 16, wherein the periodic payments are monthly and equal to a percentage between 0.5% and 2.5% of the death benefit upon commencement of the periodic payments.

18. The non-transitory computer-readable medium of claim 16, wherein an owner may select an amount of the periodic payments less than an available amount.

19. The non-transitory computer-readable medium of claim 16, wherein the instructions further cause the processor to, responsive to determining that the premium payments in accordance with the schedule will not cause the policy protection account balance to reach the target balance by the benefit eligibility date, determine a new premium schedule that will cause the policy protection account balance to reach the target balance by the benefit eligibility date, and provide an output signal having data indicative of the new premium schedule.

20. A computer system for processing data related to a permanent life insurance policy having a death benefit, comprising:
a data storage device storing data indicative of a policy owner, an insured under the policy, a death benefit amount, payable under the policy to a beneficiary upon death of the insured, and a withdrawal benefit in the nature of periodic payments payable to the policy owner upon request and on condition of the insured being living and having reached a minimum age achieved at a benefit eligibility date, and on a condition related to a likelihood of policy lapse prior to death of the insured, each payment reducing the amount of the death benefit until a residual death benefit amount is reached; and
a processor in communication with the data storage device, the processor configured to:
determine, based on the schedule of premium payments, and the benefit eligibility date, whether premium payments in accordance with the schedule will cause the condition related to a likelihood of policy lapse prior to death of the insured to be met; and
provide an output signal having data indicative of the determination whether premium payments in accordance with the schedule will cause the condition related to a likelihood of policy lapse prior to death of the insured to be met.

21. The computer system of claim 20, wherein the condition related to a likelihood of policy lapse prior to death of the insured comprises a threshold value of a factor based on amount and timing of premiums paid and policy face value.

22. The computer system of claim 21, wherein the threshold value of the factor comprises a minimum value of the factor at the benefit eligibility date.

23. The computer system of claim 20, wherein the processor is further configured to, responsive to determining that the premium payments in accordance with the schedule will not cause the condition to be met, determine a new premium schedule that will cause the condition to be met, and to provide an output signal having data indicative of the new premium schedule.

24. A computer-implemented method for processing data related to a permanent life insurance policy having a death benefit, comprising:
accessing by the processor from a data storage device data indicative of a schedule of premium payments, wherein the owner is eligible for a withdrawal benefit in the nature of periodic payments payable to the owner upon request and on satisfying a condition related to a likelihood of policy lapse prior to death of the insured;
determining by the processor, based on the schedule of premium payments, whether premium payments in accordance with the schedule will cause the condition to be met; and
providing by the processor an output signal having data indicative of the determination whether premium payments in accordance with the schedule will cause the condition to be met.

25. The computer-implemented method of claim 24, wherein the condition related to a likelihood of policy lapse prior to death of the insured comprises a threshold value of a factor based on amount and timing of premiums paid, policy face value, and policy loans.

26. The computer-implemented method of claim 25, wherein the threshold value of the factor comprises a minimum value of the factor at the benefit eligibility date, the value of the factor being increased by premium payments and reduced by policy loans.

27. The computer-implemented method of claim 24, further comprising, responsive to determining that the premium payments in accordance with the schedule will not cause the condition to be met, determining a new premium schedule that will cause the condition to be met, and providing an output signal having data indicative of the new premium schedule.

28. A computer system for processing data related to a permanent life insurance policy having an owner and a death benefit payable to a beneficiary upon death of an insured, comprising:
a data storage device having stored therein data indicative of the policy owner, the insured, and the death benefit amount; and
a processor in communication with the data storage device, the processor configured to:
receive data indicative of a request from the policy owner for an accelerated death benefit payment,
determine whether the insured has reached a minimum age,
responsive to determining that the insured has reached the minimum age, providing an output signal having data indicative of instructions to make periodic payments to the owner, and
determine, responsive to each of the periodic payments, a reduced amount of the death benefit.

29. The computer system of claim 28, wherein the processor is further configured to provide an output signal having data indicative of instructions to cease the periodic payments responsive to receiving data indicative of death of the insured.

30. The computer system of claim 28, wherein the processor is configured to determine a maximum available amount of the periodic payments based on a death benefit amount and a fraction of the death benefit amount, the maximum annually available amount being between 6% and 18% of the death benefit.

31. The computer system of claim 28, wherein the minimum age is at least 85 years.

32. The computer system of claim 28, wherein the processor is further configured to, responsive to receipt of data indicative of a medical condition of the insured, provide an output signal with data to provide periodic payments for a medical condition to the owner, the periodic payments for a medical condition reducing the death benefit amount.

33. The computer system of claim 32, wherein the medical condition of the insured comprises a chronic illness, wherein a chronic illness is one of: unable to perform without substantial assistance from another individual at least two activities of daily living and requiring substantial supervision from another individual to protect the insured from threats to health and safety due to a severe cognitive impairment.

34. The computer system of claim 33, wherein the processor is further configured to, responsive to receiving a request for periodic payments based on minimum age, and of a medical condition of the insured, provide payments based only on one of minimum age and a medical condition.

35. The computer system of claim 34, wherein the periodic payments based on the minimum age of the insured are a smaller proportion of the death benefit than the periodic payments based on a medical condition.

36. A computer system for generating retirement plan illustrations, comprising:
a storage device storing data indicative of rates and rules for a permanent life insurance policy having a withdrawal benefit, in the nature of periodic payments based in amount on the death benefit and reducing the death benefit until a residual death benefit amount is reached, available based on a minimum age of an insured, and
a processor configured to: receive data indicative of a retirement plan for at least an insured, comprising contribution data over a time period, growth data related to the contributions, and retirement income and asset assumptions;
generate an illustration for the retirement plan with a permanent life insurance policy having a withdrawal benefit, with premiums reducing the contribution data, the processor being configured to calculate the reduced contribution data and reduced retirement income and asset assumptions, and to calculate and include in the illustration income data based on the withdrawal benefit commencing at the minimum age of the insured.

37. The computer system of claim 36, wherein the minimum age is at least age 85.

38. The computer system of claim 36, wherein the illustration further comprises an amount of the death benefit under the permanent life insurance policy.

39. A computer-implemented method for generating retirement plan illustrations, comprising:
accessing by a processor from a data storage device data indicative of a retirement plan for at least an insured, comprising contribution data over a time period, growth data related to the contributions, and retirement income and asset assumptions;
generating by the processor an illustration for the retirement plan with a permanent life insurance policy having a withdrawal benefit available at a fixed age of the insured, the withdrawal benefit being in the nature of periodic payments based in amount on the death benefit and reducing the death benefit until a residual death benefit amount is reached, with premiums reducing the contribution data, the generating comprising calculating the reduced contribution data and reduced retirement income and asset assumptions, and calculating and including in the illustration income data based on the periodic payments commencing at a minimum age of the insured.

40. The computer-implemented method of claim 39, further comprising displaying, by a display device in communication with the processor, the illustration.

41. The computer-implemented method of claim 39, further comprising calculating and providing in the illustration periodic payments provided under the policy based on certification of a medical condition of the insured, the periodic payments based on certification of the medical condition reducing the death benefit amount.
